(19) United States
(12) Patent Application Publication
(10) Pub. No.: US 2026/0056517 A1
(43) Pub. Date: Feb. 26, 2026

(54) A SYSTEM AND METHOD OF CONTROLLING A SWARM OF AGENTS

(71) Applicants: RAMOT AT TEL-AVIV UNIVERSITY LTD., Tel Aviv (IL); ARIEL SCIENTIFIC INNOVATIONS LTD., Ariel (IL)

(72) Inventors: Irad BEN-GAL, Tel Aviv (IL); Barouch MATZLIACH, Tel Aviv (IL); Evgeny KAGAN, Bat Yam (IL)

(21) Appl. No.: 19/104,681

(22) PCT Filed: Jun. 29, 2023
(86) PCT No.: PCT/IL2023/050674

§ 371 Date: Feb. 18, 2025

(30) Foreign Application Priority Data
Aug. 21, 2022 (IL) 295792

(51) Int. Cl. G05B 13/02

(52) U.S. Cl. CPC G05B 13/027

(57) ABSTRACT

A system and method of distributed controlling of movement of a plurality of agents may include: associating each agent with a respective turn, and at each turn, performing the following steps by the associated agent: receiving a probability map, comprising probability values representing probability of location of one or more targets in an area of interest; applying a Neural Network (NN) model on the probability map to produce Predicted Cumulative Reward (PCR) values, where each PCR value (i) corresponds to a respective optional movement action of the agent and (ii) predicts a future cumulative reward representing aggregation of data in the probability map by the plurality of agents; moving the associated agent based on the PCR values; receiving a signal indicating location of targets in the area of interest; updating the probability map, based on the received signal; and transferring the turn to subsequent agents of the plurality of agents.

### CROSS-REFERENCE TO RELATED APPLICATIONS

This application claims the benefit of priority of Israeli Patent Application No. 295792, titled “A SYSTEM AND METHOD OF CONTROLLING A SWARM OF AGENTS”, filed Aug. 21, 2022, all of which are hereby incorporated by reference in their entirety.

### FIELD OF THE INVENTION

The present invention generally relates to AI-based systems for controlling agents. More specifically, the present invention relates to methods of reinforced learning for controlling multiple agents.

### BACKGROUND OF THE INVENTION

The use of agents, such as drones or robots which act as part of a group or a swarm, each having autonomous, or semi-autonomous navigation and movement capabilities has become increasingly popular in a variety of fields and applications. However, the autonomous control of such groups or swarms, and the efficient collaboration among members of these swarms, to perform a common goal in noisy, uncertain environments has remained a challenging task.

### SUMMARY OF THE INVENTION

Embodiments of the invention address the problem of probabilistic search and detection of multiple targets by a group or swarm of mobile agents that are equipped by various, different sensors and share information on different levels, to optimally perform a common task, such as detection of targets in a noisy environment.

The term “agent” may be used in this context to refer to a mobile element, such as a drone or a robot, configured to move (e.g., drive or fly) in an autonomous, or semi-autonomous manner, as elaborated herein. The terms “swarm” or “group” may be used in this context to refer to a plurality of member agents, configured to collaborate to conduct or move each member agent so as to obtain a common task, as elaborated herein.

Implementations of the present invention may include, for example, military applications, where detection of targets may include fusing of data from various sensors, installed on multiple platforms or agents. Non-limiting examples brought herein may be centered upon such applications for generating a map of targets in a noisy environment, in an optimal manner (e.g., consuming the minimal amount of time, hardware and/or software resources). However, as may be appreciated by a person skilled in the art, the present invention may also be integrated into other applications, where efficient collaboration among multiple agents in a swarm is required.

For example, the present invention may be integrated into homeland security applications such as border protection, protection of facilities (e.g., pipelines, airports, industrial areas), maritime domain awareness, and the like.

In another example, the present invention may be implemented for civilian applications, that rely on probability maps for smart city maintenance. Such applications may include for example searching for water or sewage leakage, searching for electric grid failures, providing location-based services, such as distribution of elements such as goods, food, drink, medication, and the like.

Embodiments of the invention may include a method of iteratively controlling movement of at least one agent, by at least one processor. According to some embodiments, each iteration may include receiving an initial probability map, that may include one or more probability values, each representing probability of location of one or more targets in an area of interest; applying a Neural Network (NN) model on the probability map to produce, based on the one or more probability values, one or more Predicted Cumulative Reward (PCR) values, corresponding to respective one or more optional movement actions of the at least one agent; selecting a movement action of the one or more optional movement actions, based on the PCR values; moving the at least one agent according to the selected movement action; receiving, from at least one first sensor associated with the agent, a target signal indicating a location of at least one target of the one or more targets; and updating the probability map, based on the received target signal.

According to some embodiments, each iteration may further include receiving, from at least one second sensor associated with the agent, at least one location data element, representing a respective location of the at least one agent.

According to some embodiments, the NN model may be configured to produce the one or more PCR values based on the probability map and the at least one location data element. In such embodiments, each iteration may further include calculating a reward value, representing an amount of data that is added in the updated probability map following the movement of the at least one agent; based on the reward value, calculating an error value that corresponds to the selected movement action, wherein said error value represents an error in the predicted PCR value; and updating one or more weights of the NN model so as to minimize the error value.

According to some embodiments, the at least one agent may include a plurality of agents, and each iteration may correspond to, or be dedicated to movement of a specific, respective, selected agent of the plurality of agents.

In such embodiments, each iteration may further include moving the respective agent according to the selected movement action; updating the weights of the NN model based on the reward value, as calculated following movement of the respective agent; and distributing the updated weights of the NN model among the plurality of agents. Additionally, or alternatively, in such embodiments each iteration may further include updating the probability map based on the target signal of the respective agent; and distributing the updated probability map among the plurality of agents. Additionally, or alternatively, in such embodiments each iteration may further include distributing the location data elements of the respective agent, among the plurality of agents; and further applying the NN model on the location data elements of two or more agents, to produce said PCR values.

According to some embodiments, the at least one agent may include a plurality of agents, and wherein each iteration corresponds to movement of a specific, first agent. In such embodiments, each iteration further may include selecting (e.g., by the first agent) a second agent for a subsequent iteration. Such selection may be based on at least one of: (i) a distance of the first agent from a predefined location in the area of interest, (ii) a distance of the second agent from a predefined location in the area of interest, and (iii) a distance between the first agent and the second agent, as elaborated herein. According to some embodiments, the first agent may then communicate the selection to the second agent, thereby dedicating a subsequent iteration to movement of the selected, second, agent.

According to some embodiments, the NN may be a reinforcement learning or Q-learning network, and wherein each PCR value represents a cumulative value of rewards of future iterations, that is expected until a predefined stop condition is met. In such embodiments, the stop condition may be, for example having obtained a predefined number of targets represented in the probability map, by a respective number of probability values, that exceed a predefined threshold.

Embodiments of the invention may include a system for iteratively controlling at least one agent. Embodiments of the system may include: a non-transitory memory device, wherein modules of instruction code are stored, and at least one processor of the at least one agent, said processor associated with the memory device, and configured to execute the modules of instruction code.

Upon execution of said modules of instruction code, the at least one processor may be configured to receive an initial probability map, that may include one or more probability values, each representing probability of location of one or more targets in an area of interest; apply a NN model on the probability map to produce, based on the one or more probability values, one or more PCR values, corresponding to respective one or more optional movement actions of the at least one agent; select a movement action of the one or more optional movement actions, based on the PCR values; move the at least one agent according to the selected movement action; receive, from at least one first sensor associated with the agent, a target signal indicating a location of at least one target of the one or more targets; and update the probability map, based on the received target signal.

According to some embodiments, the at least one agent may include a plurality or swarm of agents, and wherein each iteration corresponds to movement of a respective selected agent of the swarm of agents. In such embodiments, the at least one processor of the selected agent may be configured to, in each iteration: move the respective agent according to the selected movement action; update the weights of the NN model based on the reward value, as calculated following movement of the respective agent; and distribute the updated weights of the NN model among the plurality of agents.

Additionally, or alternatively, in such embodiments, the at least one processor of the selected agent may be configured to, in each iteration, move the respective agent according to the selected movement action; update the probability map based on the target signal of the respective agent; and distribute the updated probability map among the plurality of agents.

Additionally, or alternatively, in such embodiments, the at least one processor of the selected agent may be configured to, in each iteration, distribute the location data elements of the respective agent, among the plurality of agents; and further apply the NN model on the location data elements of two or more agents, to produce said PCR values.

According to some embodiments, the at least one agent may include a plurality or swarm of agents, and each iteration may correspond to, or be dedicated to movement of a respective first agent of the swarm. In such embodiments, each iteration may further include selecting, by the one or more agents (e.g., the first agent) of the swarm a second agent for a subsequent iteration. This selection may be based on at least one of: (i) a distance of the first agent from a predefined location in the area of interest, (ii) a distance of the second agent from a predefined location in the area of interest, and (iii) a distance between the first agent and the second agent, as elaborated herein.

Embodiments of the invention may include a method of distributed controlling of movement of a plurality of agents such as autonomous vehicles or drones. Embodiments of the method may include associating each agent of the plurality of agents with a respective turn or iteration. At each turn or iteration, embodiments may include performing the following steps by at least one processor or controller of the associated agent:

The at least one processor or controller of the associated agent may receive a probability map, that may include one or more probability values. Each probability values may represent probability of location of one or more targets in an area of interest. The at least one processor or controller may subsequently apply an NN model on the probability map to produce one or more PCR values, where each PCR value (i) corresponds to a respective optional movement action of the associated agent, and (ii) predicts a future cumulative reward representing aggregation of data in the probability map by a subset of the plurality of agents. The at least one processor or controller may control a motor or attenuator the associated agent, to move the associated agent based on the one or more PCR values. The at least one processor or controller may subsequently receive a signal indicating a location of at least one target in the area of interest (e.g., at the agent's new location), and update the probability map, based on the received signal, e.g., to aggregate target information in the probability map. The at least one processor or controller may then transfer the turn or iteration to one or more other, subsequent agents of the plurality of agents, which may repeat the above steps as new associated agents.

According to some embodiments, each turn or iteration may be dedicated to a movement action of a single, associated agent. Additionally, or alternatively, the subset may include two or more agents of the plurality of agents. In such embodiments, each turn or iteration may be dedicated to a movement action of the subset of agents, that may include more than one agent.

According to some embodiments, moving the associated agent may include selecting an optional movement action that corresponds to a maximal PCR value of the one or more PCR values; and moving the associated agent according to the selected optional movement action.

Additionally, or alternatively, at each turn, the at least one processor of the associated agent may be further configured to: calculate an instant reward value, representing addition of data in the probability map as a result of moving the associated agent; based on the instant reward value, calculate a revised PCR value that corresponds to the selected optional movement action; calculate a difference between the maximal PCR value and the revised PCR value; and retrain the NN model based on said difference.

According to some embodiments, transferring the turn may include sharing of information among agents of consecutive turns. For example, an agent associated with a first turn or iteration may transmit at least one of: (i) weights of the NN model, and (ii) the updated probability map, to the subset (e.g., one or more) of the plurality of agents that are associated with a subsequent turn or iteration. The one or more processors of the one or more subsequent agents may, in turn, perform the aforementioned steps as new associated agents.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting a computing device, which may be included within an embodiment of a system for controlling movement of at least one agent, according to some embodiments;

FIGS. 2A and 2B are simplified block diagrams depicting optional implementations of a system 10 for controlling movement of one or more agents 20 (e.g., 20A, 20B) in a swarm of agents 20′, according to some embodiments;

FIG. 3 is a simplified block diagram depicting components of an agent, according to some embodiments of the invention;

FIG. 4 is a simplified flow diagram, hierarchically depicting the integration of sensory information by a map generation module, to produce a global probability map, according to some embodiments of the invention;

FIG. 5 is a simplified diagram depicting an example of an implementation of a neural network for implementing a reinforcement learning algorithm, according to some embodiments of the invention;

FIG. 6 is a simplified diagram depicting an example of a process of training a NN 250 to implement a reinforcement learning, or Q-learning algorithm, according to some embodiments of the invention;

FIG. 7 is a flow diagram depicting a simplified example of a method of controlling one or more (e.g., a plurality or swarm of) agents, based on a reinforcement learning, or Q-learning algorithm, according to some embodiments;

FIG. 8 is a schematic diagram depicting a process of receiving information and updating a probability map according to some embodiments of the invention;

FIG. 9, is a schematic diagram depicting a scheme of data flow in a training stage of a neural network according to some embodiments of the invention;

FIG. 10 is a schematic diagram depicting the actions of an offline model-based learning procedure of a Q-max algorithm, according to some embodiments of the invention;

FIG. 11 is a graph depicting change in a temporal difference learning error with respect to the number of training epochs, according to some embodiments of the invention;

FIG. 12A shows a discounted cumulative reward for a Q-max algorithm in comparison with that of the random detection process, according to some embodiments, and FIG. 12B shows similar graphs for an SPL algorithm and the random detection process, according to some embodiments;

FIG. 13A, is a graph depicting the discounted cumulative reward for the Q-max algorithm, in comparison with a COV algorithm and the random detection process, according to some embodiments of the invention, and FIG. 13B, is a graph depicting similar graphs for the SPL algorithm compared to the COV algorithm and the random detection process, according to some embodiments of the invention;

FIG. 14A and FIG. 14B are column graphs depicting a number of agent actions in detecting two static targets with the SPL/Q-max algorithms and the COV algorithm, according to some embodiments;

FIG. 15 is a graph showing an example of dependence of detection probabilities on the number of planned actions for the SPL algorithm and a DP algorithm, according to some embodiments of the invention;

FIG. 16 is a graph showing dependence of detection probabilities on false alarm rate, according to some embodiments of the invention;

FIG. 17 is a schematic block diagram depicting actions of an offline model-based learning procedure, implementing a Q-max algorithm, according to some embodiments of the invention; and

FIG. 18 is a flow diagram depicting a method of distributed controlling of movement of a plurality of agents according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

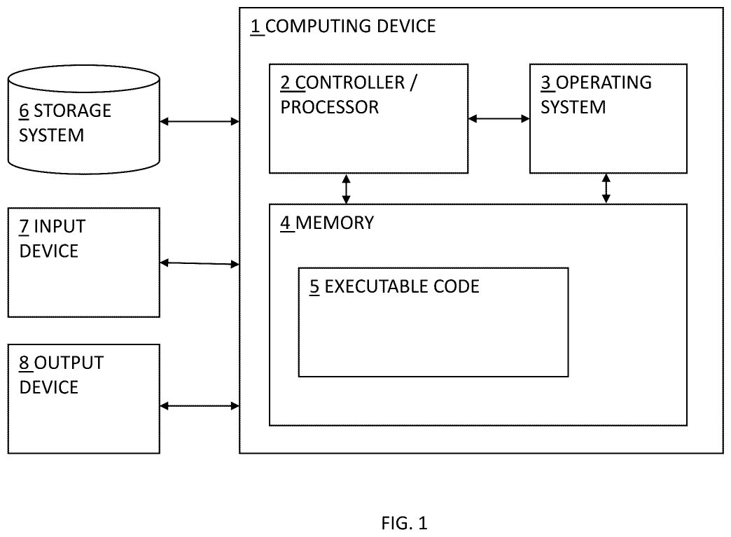

Reference is now made to FIG. 1, which is a block diagram depicting a computing device, which may be included within an embodiment of a system for controlling movement of at least one agent, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may control movement of at least one agent as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to one or more agents may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

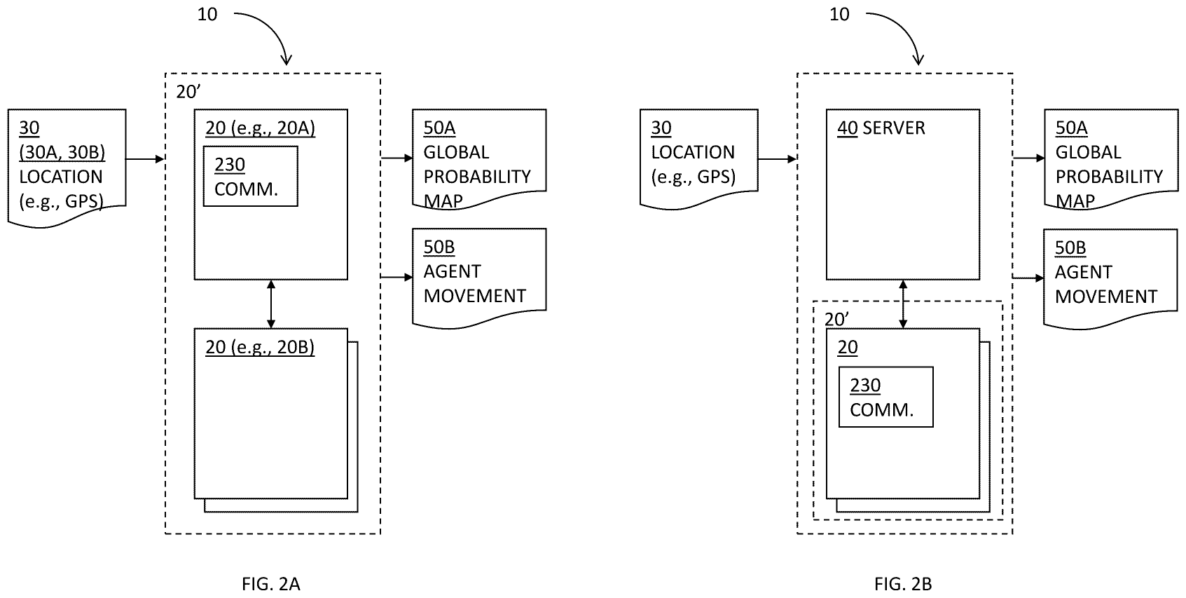

Reference is now made to FIGS. 2A and 2B, which are simplified block diagrams depicting optional implementations of a system 10 for controlling movement of one or more agents 20 (e.g., 20A, 20B) in a swarm of agents 20′, according to some embodiments. Each agent 20 may be, or may include a mobile element, such as a drone or a robot, configured to move (e.g., drive over a terrain, propel through water, fly through air), as known in the art. Additionally, each agent 20 may include at least one computing device (e.g., element 1 of FIG. 1), configured to control or conduct the respective agent so as to move the agent in a desired direction, as elaborated herein.

As shown in FIG. 2A, system 10 may include a plurality of agents 20, configured to receive location data 30, representing location of the one or more agents 20.

For example, one or more agents 20 of the plurality of agents 20′ may include a Global Positioning System (GPS) receiver, adapted to receive GPS information from one or more satellites, thus allowing agent 20 to determine its own location with respect to the Earth. This type of location data 30 is referred to herein as “self location 30A” data.

Additionally, or alternatively, one or more agents 20 of the plurality of agents 20′ may include a communication module 230, adapted to receive (e.g., via a wireless communication channel, such as a Radio Frequency (RF) communication channel), location data 30 from one or more additional member agents 20. Location data 30 may represent a location or position of one or more member agents 20, other than itself. This type of location data 30 is referred to herein as “member location 30B” data. The one or more agents 20 of the swarm of agents 20′ may be configured to distribute, or transmit their location data elements 30A (now denoted 30B) among the plurality of agents 20′, either directly, or via server 40.

As elaborated herein, the plurality or swarm 20′ of agents 20 of FIG. 2B may collaborate among themselves to move, or control a movement 50B of one or more member agents 20 of the swarm of agents 20′. Additionally, or alternatively, the plurality of agents 20 of FIG. 2B may collaborate among themselves to produce a global probability map 50A, representing location and/or existence of one or more targets in a predefined area.

As shown in FIG. 2B, system 10 may further include a server computing device 40 (e.g., such as element 1 of FIG. 1). In such embodiments, server 40 may be configured to communicate with the one or more agents 20 (e.g., via communication module 230 and a wireless communication channel, such as an RF communication channel). As elaborated herein, agents 20 may collaborate with server 40 via this communication channel to move, or control a movement 50B of one or more member agents 20 of swarm 20′. Additionally, or alternatively, the plurality of agents 20 of FIG. 2B may collaborate with server 40 via the communication channel to produce global probability map 50A, as elaborated herein.

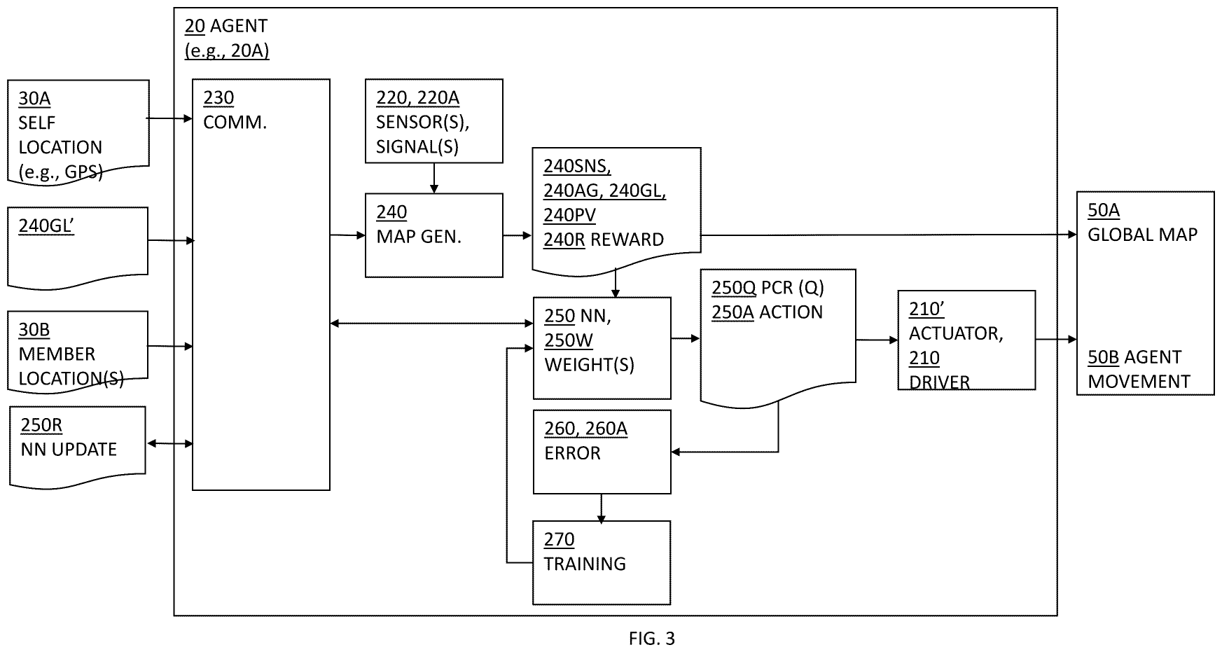

Reference is now made to FIG. 3, which is a simplified block diagram depicting components of an agent 20, according to some embodiments of the invention.

According to some embodiments of the invention, agent 20 may be implemented as any combination of software modules and hardware modules.

For example, agent 20 may include one or more motors or actuators 210 for propelling and/or steering (e.g., flying) agent 20. Additionally, or alternatively, agent 20 may include a computing device such as element 1 of FIG. 1, adapted to execute one or more modules of executable code (e.g., element 5 of FIG. 1) to control movement 50B of agent 20 as further described herein.

As shown in FIG. 3, arrows may represent flow of one or more data elements to and from agent 20 and/or among modules or elements of agent 20. Some arrows have been omitted in FIG. 3 for the purpose of clarity.

According to some embodiments, each agent 20 may maintain a Neural Network (NN) model 250, and may be configured to individually select a specific movement from a plurality of optional movements, based on the NN model 250, as elaborated herein.

In such embodiments, system 10 may be configured to control movement 50B of the at least one agent 20, and/or produce global probability map 50A in an iterative process. Each iteration of this iterative process may include (a) movement of at least one, or exactly one agent 20 of the agent swarm 20′, (b) acquisition of information from one or more sensors 220, pertaining to one or more targets, at the agent's 20 new location, (c) global (e.g., at one or more agents 20) update of the NN 250 weights or coefficients (e.g., retraining of the NN), and (d) update of the global map 50A. This iterative process may repeat or continue (e.g., through multiple iterations over time), until a predefined condition is met, as elaborated herein.

According to some embodiments, one or more (e.g., all) agents 20 may include one or more respective sensors 220, adapted to sense or identify at least one target within a predefined region or area surrounding the relevant agent's location. For example, agent 20 may be a drone, deployed over a predefined area, and sensors 220 may be, or may include radar sensors 220 and/or Light Detection and Ranging (LIDAR) sensors 220, adapted to sense or locate targets such as vehicles within the predefined area.

It may be appreciated that agent 20 may obtain, from at least one first sensor 220 associated with, or included in agent 20, a target signal 220A indicating location or existence of at least one target of one or more targets in the predefined region. However, noisy real-world environments may create a large number of false alarm events. In other words, target signals 220A obtained from a single sensor 220 or event from multiple sensors 220 associated with a single agent 20 may be noisy and inaccurate.

Embodiments of the invention may overcome this impediment by collecting information from a plurality of sensors, and hierarchically integrating this information.

As shown in FIG. 3, at least one (e.g., each) agent 20 may include a map generation module 240, configured to integrate sensor signals 220A, originating from a plurality of sensors, thereby filtering false alarm events and improving detection of targets in the predefined area of interest.

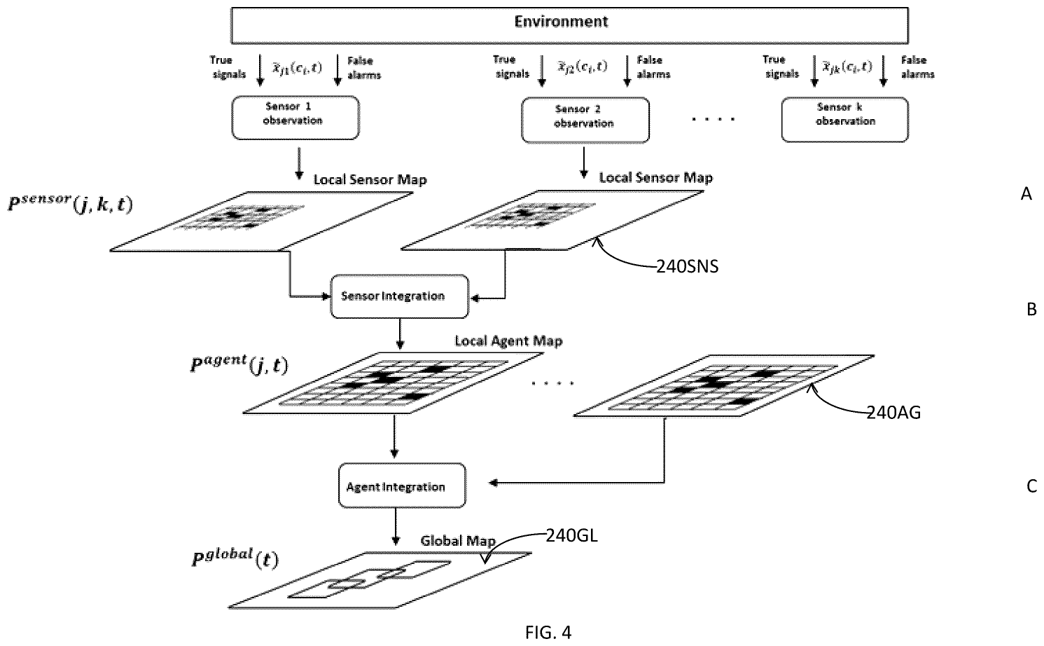

Reference is also made to FIG. 4, which is a simplified flow diagram hierarchically depicting the integration of sensory information by map generation module 240, to produce a global map 50A (also denoted herein as global probability map 240GL), according to some embodiments of the invention.

These capabilities are achieved by advanced reinforcement learning deep networks combined with various ‘Bayesian’ schemes. These deep networks models include real-time updating of the location probabilities 240PV of the targets within a defined search area, integrating the various sensors' outputs as well as auxiliary information to generate a global location-probability map 240GL, by integrating information from a plurality of agents 20 under different information-sharing policies. For example, in order to decrease the quantity of transferred information and of the computations, instead of a global probability map, the partial or individual maps can be used. In this scenario, agent 20 may share only those positions of the cells in which the probabilities 240PV of detecting the targets are relatively high (e.g., beyond a predefined threshold).

For example, as depicted in stage A of FIG. 4, map generation module 240 may receive sensor signals 220A, originating from a plurality of sensors 220 pertaining to a single agent 20. Map generation module 240 may produce, for each of these sensors 220, a corresponding sensor-level probability map 240SNS. The term “probability map” may be used herein to represent a data structure (e.g., a table) that includes probabilistic information pertaining to existence and/or location of targets in an area of interest. For example, sensor-level probability map 240SNS may be presented as a heat map, where the indices of each pixel represent corresponding longitude and latitude of a location in a geographical region of interest, and where the value, or “heat” of each pixel represents a probability, or confidence of existence of a target in the respective location. Sensor-level probability map 240SNS is also denoted herein p^{sensor} (j, k, t), where ‘t’ denotes targets to be discovered by swarm 20′, ‘j’ denotes an index of specific agents 20, and ‘k’ denotes an index of specific sensors 220.

As depicted in stage B of FIG. 4, map generation module 240 may integrate the plurality of sensor-level probability maps 240SNS to produce, for each agent 20, an agent-level probability map 240AG. For example, map generation module 240 may fuse sensor information 220A by translating the signals received by sensors 220 to a sensor probability map 240SNS, and using a Bayesian inference approach to integrate these maps into an agent-level probability map 240AG.

Additionally, as depicted in FIG. 3, map generation module 240 may collaborate with communication module 230, to receive agent-level probability maps 240AG′ of other member agents 20. For example, as depicted in the exemplary configuration of FIG. 2A, communication module 230 may be communicate via a wireless communication channel with communication modules 230 of other, respective agents 20, to receive their agent-level probability maps 240AG′. Additionally, or alternatively, as depicted in the exemplary configuration of FIG. 2B, communication module 230 may be communicate via a wireless communication channel with server 40 to receive agent-level probability maps 240AG′ of other agents 20. Map generation module 240 may subsequently integrate the plurality of agent-level probability maps 240AG/240AG′ to produce a global (e.g., pertaining to multiple, or all agents 20) probability map 240GL. For example, Map generation module 240 may create global probability map 240GL integrating multiple agent-level probability maps 240AG/240AG′ into a common, centralized map, using a similar method as explained herein in relation to integration of different sensor-level maps 40A.

According to some embodiments, system 10 may be configured to autonomously detect targets systems within large search areas. System 10 may be based on explicit search algorithms and decision-making methods using artificial intelligence and machine learning methods such as deep reinforcement learning (e.g., Q-learning), implemented by NN 250, as elaborated herein.

According to some embodiments, agents 20 may starts with an initial global probability map 240GL of the targets' locations, and may decide their actions regarding further movements either by maximizing the expected cumulative information gain regarding the targets' locations or by minimizing the expected length of the agent's trajectory up to obtaining the desired probability map.

The maximization of the expected information gain, and/or minimization of the expected path length may be performed by a dynamic programming approach, while the decision regarding the next step of the agent is obtained by the deep Q-learning of NN 250.

NN 250 may receive as input (a) the agent location 30A/30B, and (b) a current, updated version of global probability map 240GL (50A). NN 250 may output a preferred action (e.g., movement) of the agent. The a-priori training of the network may be conducted on the basis of a set of simulated realizations of the considered detection process.

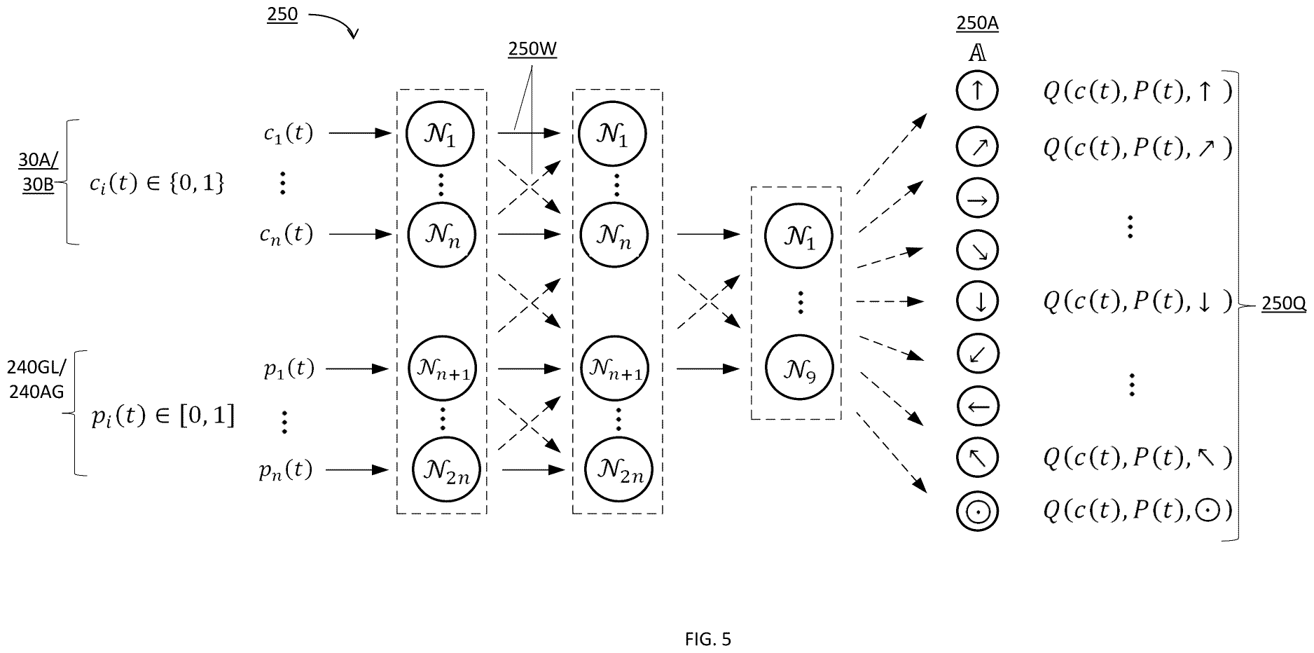

Reference is also made to FIG. 5, which is a simplified diagram depicting an example of an implementation of NN 250 for implementing a reinforcement learning algorithm, according to some embodiments of the invention.

The learning stage in the suggested Q-learning algorithm is based on NN 250 combined with dynamic programming of predicted cumulative rewards 250Q.

As depicted in the simple, but rather effective example of FIG. 5, NN 250 may include one input layer, which includes 2n neurons, where n is the size of the domain.

For example, the area of interest may be divided into n cells. The input layer may include a first group of inputs (denoted C₁(t), . . . , Cₙ(t)), which represent a binary notation (e.g., ‘0’ or ‘1’) of temporal location 30A/30B of agents in each cell. In other words, a ‘1’ value in a cell Cᵢ(t) may represent existence of an agent 20 in that cell, at time t, whereas a ‘0’ value in cell Cᵢ(t) may represent existence of an agent 20 in that cell, at that time.

Additionally, or alternatively, the input layer may include a second group of inputs (denoted P₁(t), . . . , Pₙ(t)), which represent values of global probability map 240GL for each cell of the n cells, at time t.

As depicted in the example of FIG. 5, NN 250 may further include one hidden layer (e.g., a fully connected layer), which also includes 2n neurons, and an output layer, which includes nine neurons. These nine neurons correspond to the number of possible actions for moving agent 20, as depicted by eight arrows: “forward”, “right-forward”, “right”, “right-backward”, “backward”, “left-backward”, “left”, “left-forward”, and “stay in the current cell”, as depicted by the ‘⊙’ symbol. In this example, the action space [symbol] (e.g., the number of possible actions that each agent may take) may be defined as [symbol] =9.

As known in the field of reinforcement learning, each action of the action space [symbol] may be linked to a Predicted Cumulative Reward (PCR) value (e.g., element 250Q of FIG. 3), also denoted herein as ‘Q’ values. For example, as depicted in the FIG. 5, a first action of moving to an adjacent cell on the forward direction (denoted by an ‘↑’ symbol) is associated with a first PCR value 250Q (Q(c(t), P(t), ↑)), a second action of moving to an adjacent cell on the right direction (e.g., denoted by an ‘→’ symbol) is associated with a second PCR value 250Q (Q(c(t), P(t), →)), etc.

According to some embodiments, system 10 may be configured to produce global probability map 240GL by optimally controlling a plurality or swarm 20′ of agents 20, while fusing the information conveyed by sensor signals 220 from one or more (e.g., all) sensors 220 in the swarm. Accordingly, a reward 240R may be referred to herein as the amount of information that has been obtained by moving a single agent, in a specific direction.

In other words: an initial global probability map 240GL P(t) may represent confidence levels of existence of targets in each cell of n cells of the area of interest. By moving an agent 20 from a first position 30A at time t to a second position 30A at time t+1, additional information may be obtained via the sensors of that agent. global probability map 240GL may be updated to reflect this change (e.g., an increase in confidence level in one or more cells).

Reward 240R may be calculated based on this change. For example, a global probability map 240GL of time t (P(t)) may be compared to the global probability map 240GL of time t+1 (e.g., P(t+1), after movement of the agent), and an immediate reward 240R may be calculated based on this comparison.

For example, given action [symbol] ∈ [symbol] at time t+1, the immediate expected informational reward 240R (denoted herein as ‘R’) of agent 20 may be defined according to equation Eq. A1 below:

$$R ( 𝕒 , t ) = {D}_{KL} ( {P}_{𝕒} ( t + 1 ) ‖ P ( t ) ) , \qquad Eq . A1$$

where D_{KL} represents the Kullback-Leibler distance between the global probability map 240GL following action [symbol] , [symbol] (t+1) and the current global probability map 240GL P(t).

Given a policy π for choosing an action, the expected cumulative discounted reward 250Q. The discount reward is related to preferred rewards in the immediate time relative to those in the distant future. The discount reward values q_{π} 250Q, obtained by an agent that starts in cell c(t) with probability map P(t) and chooses action [symbol] (t) is provided by equation Eq. A2, below:

$${q}_{π} ( c ( t ) , P ( t ) , 𝕒 ( t ) ) = {𝔼}_{π} \{ {\sum }_{τ = 0}^{∞} {γ}^{τ} R ( 𝕒 , t + τ ) \} , \qquad Eq . A2$$

where the discount factor is 0<γ≤1, and the goal is to find a maximum value of the expected cumulative reward q_{π} over all possible policies π that can be applied after action [symbol] (t) is chosen at time t, according to Eq. A3, below:

$$Q ( c ( t ) , P ( t ) , 𝕒 ( t ) ) = {max}_{π} {q}_{π} ( c ( t ) , P ( t ) , 𝕒 ( t ) ) \qquad Eq . A3$$

As known in the field of reinforcement learning, or Q-learning, each Q value (also denoted herein as PCR value 250Q of FIG. 3) may represent expected accumulated values of rewards 240R (also denoted herein as ‘R’), starting from a respective action [symbol] ∈ [symbol] at time t+1. As elaborated herein, rewards 240R may represent contribution of information to global probability map 240GL P(t). Therefore, NN 250 may be trained to predict the future cumulative reward values Q (PCR 250Q) representing, future, cumulative contribution of information to global probability map 240GL P(t) following movement of one or more (e.g., all) agents 20 of swarm 20′.

In other words, NN 250 may be a reinforcement learning network, where each PCR 250Q value represents an expected cumulative value of reward (‘R’) 240R of future iterations, that is expected until a predefined stop condition may be met. As a non-limiting example, such a stop condition may be having a predefined number of targets represented in the global probability map 240GL, by a respective number of probability values 240PV, that exceed a predefined threshold. Other such stop conditions may also be possible.

According to some embodiments, agent 20 may include a driver module 210. Driver module 210 may be configured to select a preferred action based on the future cumulative values (Q, PCR 250Q) of rewards 240R. For example, driver module 210 may be configured to identify a maximal future cumulative reward value (e.g., Q(c(t), P(t), ↑)) and select an action that corresponds to the identified maximal Q value (e.g., movement to an adjacent cell, in the forward direction ‘↑’). Driver module 210 may subsequently control at least one actuator, motor or engine 210′ (e.g., a propeller) to conduct or move 50B agent 20 according to the selected action (e.g., move to an adjacent cell, in the forward direction ‘↑’).

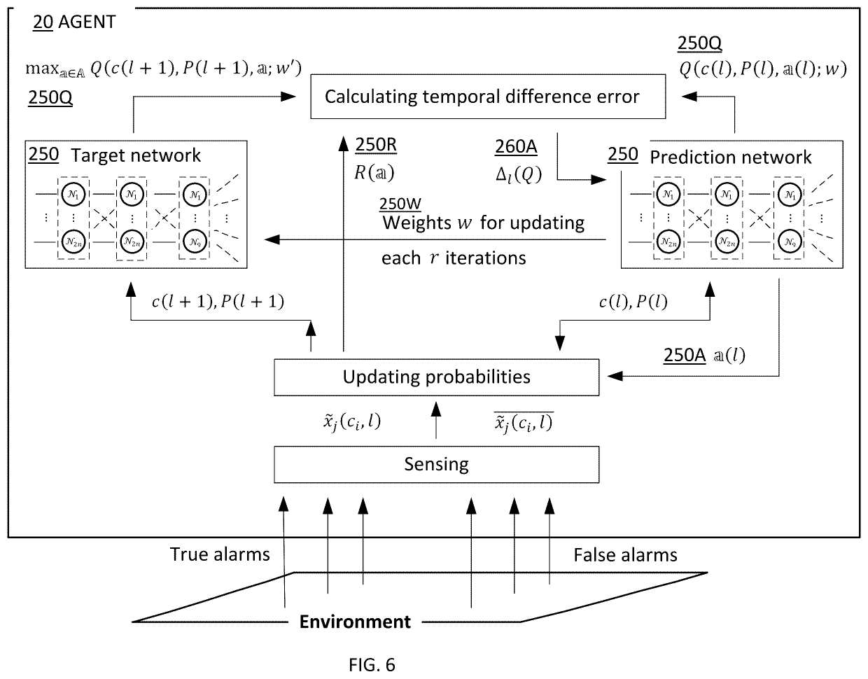

Reference is now made to FIG. 6, which is a simplified diagram depicting an example of a process of training a NN 250 to implement a reinforcement learning, or Q-learning algorithm, according to some embodiments.

As known in the art, a NN implementing reinforcement learning may be configured to predict future cumulative rewards (Q-values), in relation to each action of a plurality of optional actions. Therefore, the Q-values at iteration l (Q(l)) should be approximated by the Q-values at iteration l+1 (Q(l+1)), plus a reward value R(l+1) obtained by performing the selected action at time (l+1). It may be appreciated that reward value R(l+1), e.g., contribution of information to global probability map 240GL (‘P’) at time (l+1) depends upon the received sensor signals 220A at the new location, and is primarily unknown. A difference between Q(l) and (Q(l+1)+R(l+1)) may be defined as a temporal difference learning error al (Q).

As depicted in FIG. 3, agent 20 may include an error module 260, configured to calculate the temporal difference learning error Δₗ(Q) (also denoted herein as “error Δₗ(Q)” and “error 260A”). Additionally, agent 20 may include a training module 270, configured to train NN model 250 based, at least in part on error 260A.

As shown in the example of FIG. 6, updating of the weights w in the prediction network NN 250 (e.g., training of NN 250 by training module 270) may be conducted following back propagation techniques. For example, weights w of NN 250 for a next step or iteration, l+1, may be updated with respect to the temporal difference learning error Δₗ(Q) calculated at the current step or iteration, l. Additionally, or alternatively, weights w′ in the target network NN 250 may be updated to the values of the weights w after an arbitrary number of iterations.

It may be appreciated that the training procedure presented herein may directly use the events occurring in the environment and may not require prior knowledge of the target's abilities or actions. In other words, following this procedure, agents 20 may detect the targets in the environment and simultaneously learn the environment, while training a representative neural network NN 250, which supports the agents' 20 decision-making processes. Such a process may therefore be referred to as model-free learning, as known in the art.

The example of FIG. 6 depicts actions of the on-line, model-free learning procedure of the Q-learning algorithm. It may be appreciated that the above definitions of cumulative rewards 250Q do not depend on previous trajectories of agent 20. Hence, the process that governs the agent's 20 activity may be Markovian, with the states that include positions of the agent and corresponding probability maps. Such a property allows a use of additional off-line learning procedure based on additional knowledge of the targets' abilities.

In other words, if the abilities of the targets are known and can be represented in the form of transition probability matrices that govern the targets' motion, the learning process can be conducted off-line without checking the occurring events within the environment.

In such embodiments, the training procedure may be further based on certain knowledge of the targets' activity, and may thus be referred to as a “model-based” learning procedure, as known in the art.

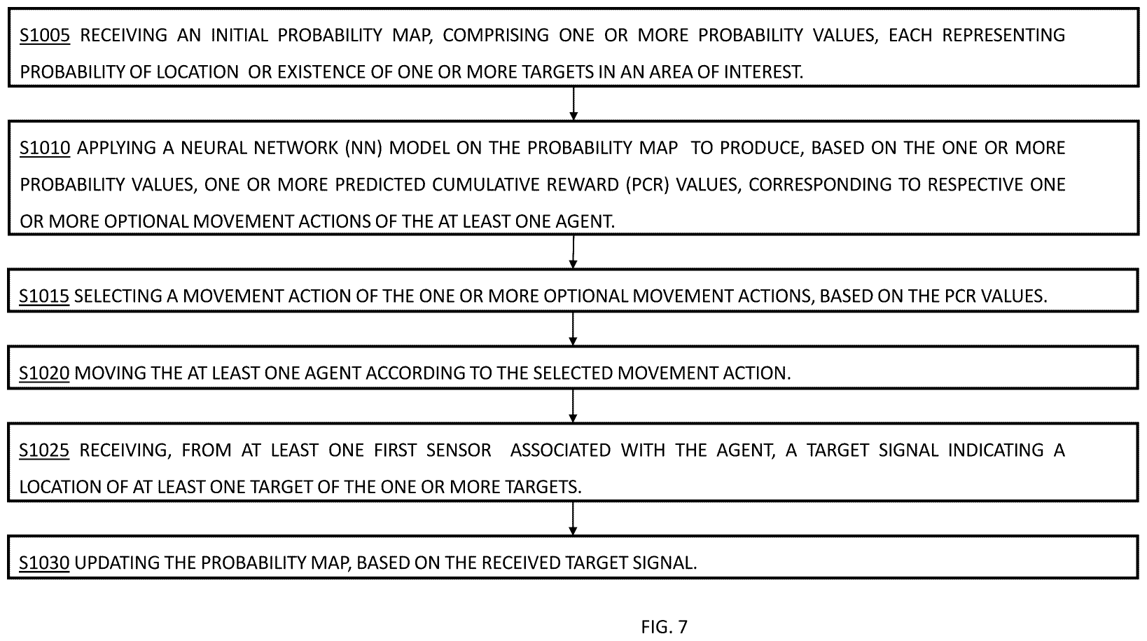

Reference is now made to FIG. 7, which is a flow diagram depicting a simplified example of a method of controlling one or more (e.g., a plurality or swarm 20′ of) agents 20, based on a reinforcement learning, or Q-learning algorithm, according to some embodiments.

As elaborated herein, controlling of the at least one agent may be performed by at least one processor (e.g., processor 2 of FIG. 1), through an iterative process.

Each iteration of the iterative process may include selection of at least one, or exactly one agent 20 (e.g., a member agent of swarm 20′), and performance of specific actions in relation to the selected agent 20.

For example, each iteration may include movement of the selected agent 20, based on the PCRs 250Q of NN 250, as elaborated herein. The selected agent 20 may receive sensor information 220A (also referred to herein as sensor signals 220), at the new location 30A. The selected agent 20 may subsequently update a global probability map 240GL based on the sensor information 220A, as elaborated herein, and send update information to the other agents 20 of swarm 20′, either directly or via server 40. This update information may include the selected agent's location 30A (now denoted 30B), and an update of global probability map 240GL (now denoted 240GL′). Additionally, the selected agent 20 may calculate error 260A and train NN 250 based on calculated error 260A to update weights w of NN 250, as elaborated herein. The selected agent 20 may then send the updated weights w of NN 250 (now denoted 240R) to the other agents 20 of swarm 20′, either directly or via server 40. Additionally, or alternatively, the selected agent 20 may collaborate with server 40 (which may possess computational resources that are superior to those of agent 20) to perform the calculation of error 260A and training of NN 250.

The iterative process may then proceed to a subsequent iteration, where a different agent 20 may be selected to perform the above actions, until a predefined stop condition is met.

According to some embodiments, selection of an agent 20 for the subsequent iteration may be based on a serial number, or identification, to traverse through the plurality of agents 20 in a serial, cyclical manner.

Additionally, or alternatively, selection of an agent 20 for the subsequent iteration may be based on (i) a distance of a first agent from a predefined location in the area of interest, (ii) a distance of a second agent 20 from a predefined location in the area of interest, and/or (iii) a distance between the first agent 20 and the second agent 20. According to some embodiments, the first agent may then communicate the selection (e.g., via communication module 230) to the second agent 20, thereby dedicating a subsequent iteration to movement of the selected, second, agent 20.

In a non-limiting example, a first iteration may be dedicated to a first agent 20. A second agent 20 may be identified as closest to the first agent 20, and may thus be selected for the subsequent (second) iteration. A third agent 20 may be identified as closest to the second agent 20 (excluding the first agent), and may thus be selected for the subsequent (third) iteration, and so forth. Additional such algorithms for selection of agents 20 for each iteration may also be used.

As shown in step S1005 of FIG. 7, in each iteration, the at least one processor 2 of agent 20 (e.g., the selected agent 20) may receive, or start with an initial probability map 240GL that includes one or more probability values 240PV, each representing probability of location or existence of one or more targets in an area of interest. For example, each probability value 240PV may represent a confidence value of target existence in a specific cell within a geographical, two-dimensional (2D) or three-dimensional (3D) region of interest.

As shown in step S1010, in each iteration, the at least one processor 2 of selected agent 20 may apply a NN model (e.g., NN 250 of FIG. 3) on the global probability map 240GL to produce, based at least in part on the one or more probability values 240PV, one or more PCR values 250Q (also denoted herein as Q values). As elaborated herein (e.g., in relation to FIG. 5), each predicted PCR 250Q value may represent an expected, accumulation of future rewards 240R (also denoted herein as R values), and may correspond to respective one or more optional actions (e.g., movement actions [symbol] ∈ [symbol] ) of the at least one agent.

Additionally, or alternatively, in each iteration the selected agent may receive, from at least one second sensor (e.g., a GPS receiver) associated with the agent, at least one self-location data element (e.g., self-location element 30A of FIG. 3), and/or member location data elements (e.g., member-location elements 30B of FIG. 3), representing respective locations or positions of the at least one selected agent 20, and/or other member agents 20 of swarm 20′. As elaborated herein (e.g., in relation to FIG. 5), NN model 250 may be configured to produce the one or more PCR values based on the probability map and further based on the at least one location data element 30A/30B. In other words, the at least one processor 2 of selected agent 20 may apply NN model 250 on the one or more probability values 240PV of global probability map 240GL and on two or more location data elements 30A/30B to produce or predict the one or more PCR (Q) values 250Q.

As shown in steps S1015 and S1020, in each iteration, the at least one processor 2 of selected agent 20 may select or choose a movement action ( [symbol] ) of the one or more optional movement actions, based on the PCR (Q) 250Q values (e.g., by selecting an action a that corresponds to a maximal predicted PCR (Q) 250Q value). Processor 2 of selected agent 20 may then control at least one motor or actuator (e.g., via driver module 210 of FIG. 3) to move or conduct the at least one agent 20 according to the selected or chosen movement action ( [symbol] ).

As shown in step S1025, in each iteration, the at least one processor 2 of selected agent 20 may receive, from at least one sensor 220 associated with the agent (e.g., a radar sensor, a LIDAR sensor, a camera, and the like), a target-related signal, or target-related information. Such target signal or information may indicate a location or existence of at least one target of one or more targets in a geographic cell or section of the geographic region of interest. As shown in step S1030, the at least one processor 2 of selected agent 20 may subsequently update the global probability map 240GL, based on the received target signal as elaborated herein (e.g., in relation to FIG. 4).

Additionally, or alternatively, in each iteration of the iterative process, the at least one processor 2 of selected agent 20 may retrain NN model 250, either independently, or in collaboration with server 40, and propagate updated weights of the retrained NN model 250 to other member agents 20 of swarm 20′.

For example, the selected agent 20 may calculate a reward value 240R (also denoted herein as ‘R’ value), which represents an amount of data that is added in the updated global probability map 240GL following movement of the at least one agent to the new location, as elaborated herein (e.g., in relation to FIG. 3). The selected agent 20 may then calculate (or query server 40 to calculate) an error value 260A that corresponds to, or is consequent to the selected movement action, based on the calculated reward 240R. As elaborated herein, error value 260A may represent an error in the predicted PCR value 250Q. The selected agent 20 may then train (or query server 40 to train) NN model 250 based, at least in part on error value 260A, so as to update one or more weights w of NN model 250 to minimize the error value 260A.

As mentioned above, the at least one selected agent may be one of a swarm 20′ or plurality of agents 20. According to some embodiments, each iteration corresponds to, or “belongs” to movement of a specific, single, respective agent 20.

In such embodiments, in each iteration, the specific agent 20 may move according to the selected or chosen movement action, and update the weights w of the NN model 250 based on the reward value 240R, as calculated following movement of that respective agent. Additionally, the specific agent 20 may subsequently distribute, or transmit the updated weights w 250W of NN model 250 among the plurality of agents 20 of the swarm, via communication module 230 of FIG. 3, either directly or via server 40.

Additionally, in each iteration, the specific, selected agent 20 may update the global probability map 240GL based on a sensor signal 220A or sensor information from a sensor 220 of the respective agent as elaborated herein (e.g., in relation to FIG. 4), and subsequently distribute, or transmit the updated probability map 240GL′ among the plurality 20′ of agents 20 via communication module 230 of FIG. 3, either directly or via server 40.

Embodiments of the invention may include a practical application for distributed control of a plurality, or swarm of agents. A non-limiting example for applying the present invention, extensively discussed herein, includes creating a probability map 240GL that depicts targets' existence and/or location under noisy, dynamic conditions.

As known in the art, currently available methods and systems that employ a reinforcement, or Q-learning algorithm, e.g., for controlling or moving an agent, are typically directed to selecting an action by optimizing an expected cumulative future reward 250Q that would be obtained by performing the action by that specific agent.

Embodiments of the invention may provide an improvement over current reinforcement learning technology: By integrating the information pertaining to all sensors in a swarm of agents, and applying the NN model 250 on locations 30B of all agents in a swarm 20′ embodiments of the invention may optimize selection of actions for any specific agent based on behaviour of the swarm as a whole, rather than the behaviour of that specific agent.

Embodiments of the invention may thus facilitate simultaneous tracking of a plurality of static or dynamic (e.g., moving) targets, by a plurality of agents, in a noisy, uncertain environment, which consists of frequent, false positive target detections.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

Embodiments of the invention may address the problem of detecting multiple static and/or mobile targets by an autonomous mobile agent acting under uncertainty. It is assumed that the agent may be able to detect targets at different distances and that the detection includes errors of the first and second types. The goal of the agent may be to plan and follow an optimal trajectory, e.g., that results in the detection of the targets in a minimal time, or a minimal number of movements.

Embodiments of the invention may implement the approach of deep Q-learning applied to maximize the cumulative information gain regarding the targets' locations and minimize the trajectory length on the map with a predefined detection probability. The Q-learning process may be based on a neural network that receives the agent location and current probability map and results in the preferred move of the agent. The inventors have compared the process of the present invention with previously developed techniques of sequential decision making, and have demonstrated that the suggested novel algorithm strongly outperforms such currently existing methods.

The detection of hidden stationary or moving targets is the first task of search procedures; this task focuses on recognizing target locations and precedes the chasing of the targets by a search agent. Usually, the solution of the detection problem is represented by a certain distribution of the search effort over the considered domain. In the simplest scenario of the detection of static targets by a static agent, agent 20 may be equipped with a sensor 220 that can obtain information (complete or incomplete) 220A from all points in the domain. Using such a sensor 220, agent 20 may screen the environment and accumulate information about the targets' locations; when the resulting accumulated information becomes sufficiently exact, agent 20 may return a map 240AG of the domain with the marked locations of the targets.

In the case of a moving agent 20, the detection process acts similarly, but it is assumed that the agent is able to move over the domain (e.g., the area of interest) to clarify the obtained information or to reach a point from which the targets can be better recognized. A decision regarding the agent's movement may be made at each step and may lead the agent 20 to follow the shortest trajectory to achieve the detection of all targets.

In a complex scenario of moving target detection, agent 20 may both move within the domain to find a better observation position and track the targets to obtain exact information about each of their locations.

It is clear that in the first scenario, agent 20 may have a passive role, and the problem is focused not on decision making, but on sensing and sensor fusion. However, in the case of a moving agent, the problem may focus on planning the agent's path.

In recent decades, several approaches have been suggested for planning the agent's motion and specifying decision-making techniques for detection tasks. Formally, such research addresses stochastic optimization methods that process offline and result in a complete agent trajectory or involve certain heuristic algorithms that allow the agent's path to be planned in real time.

In their research, the inventors have followed the direction of heuristic algorithms for search and detection with false positive and false negative detection errors and consider the detection of static and moving targets. In addition, the inventors assume that the agent may be equipped with an on-board controller that may be powerful enough to process deep Q-learning and train neural networks on relatively large data sets. A data set may be represented by an occupancy grid, and the decision making for the probability maps may follow the Bayesian approach.

The implemented deep Q-learning scheme may follow general deep learning techniques applied to search and detection processes and to navigation of mobile agents. However, in addition to usual functionality, the suggested method utilizes the knowledge about the targets' locations in the form of a probability map.

In the suggested algorithm, agent 20 may start with an initial probability map 240AG of the targets' locations, and may perform decisions regarding its further movements either by maximizing the expected cumulative information gain regarding the targets' locations or by minimizing the expected length of the agent's trajectory up to obtaining the desired probability map. For brevity, we refer to the first approach as the Q-max algorithm and the second approach as the Shortest Path Length (SPL) algorithm.

The maximization of the expected information gain and minimization of the expected path length may be performed with a conventional dynamic programming approach, while the decision regarding the next step of the agent may be obtained by the deep Q-learning of the appropriate neural network.

As an input, neural network 250 may receive the agent location 30A and current probability map 240AG, and the output may be the preferred move of the agent 20. The a-priori training of the neural network may be conducted on the basis of a set of simulated realizations of the considered detection process.

In contrast to known search algorithms with learning, the suggested algorithm allows search and detection with false positive and false negative detection errors, and, in addition to general deep learning scheme, the suggested algorithm utilizes the current agent's knowledge about the targets' locations.

Note that both features of the suggested algorithm can be used for solving the other problems that can be formulated in the terms of autonomous agents and probability maps.

The algorithm and the training data set may be implemented in the Python programming language with the PyTorch machine learning library. The performance of the algorithm may be compared with the performance of previously developed methods. It was found that the novel deep Q-learning algorithm strongly outperforms (in the sense of obtaining the shortest agent path length) the existing algorithms with sequential decision-making and no learning ability. Therefore, it enables embodiments of the invention to detect the targets to be detected in less time than the known methods.

Let C={c₁, c₂, . . . , cₙ} be a finite set of cells that represents a gridded two-dimensional domain. It is assumed that in the domain C there may be ξ targets, v=1, . . . , ξ, ξ≤n−1, which can stay in their locations or move over the set C, and an agent, which moves over the domain with the goal of detecting the targets.

Agent 20 may be equipped with an appropriate sensor 220 such that the detection probability becomes higher as the agent moves closer to the target and as the agent observes the target location for a longer time, and the goal may be to find a policy for the agent's motion such that it detects all ξ targets in minimal time or, equivalently, it follows the shortest trajectory.

This detection problem follows the Koopman framework of search and detection problems and continues the line of previously developed heuristic algorithms.

Following the occupancy grid approach, the state s(cᵢ, t) of each cell cᵢ∈C, i=1, 2, . . . , n, at time t=1, 2, . . . may be considered a random variable with the values s(cᵢ, t)∈{0,1}; s(cᵢ, t)=0 means that the cell cᵢ at time t is empty, and s(cᵢ, t)=1 means that this cell cᵢ at time t is occupied by a target. Since these two events are complementary, their probabilities 240PV may satisfy Eq. B1, below:

$$Pr \{ s ( {c}_{i} , t ) = 0 \} + Pr \{ s ( {c}_{i} , t ) = 1 \} = 1 \qquad Eq . B1$$

Detection may be considered as an ability of the agent to recognize the states si of the cells, i=1, 2, . . . , n, and it is assumed that the probability of detecting the target is governed by the Koopman exponential random search formula, as in Eq. B2, below:

$$Pr \{ target detected in {c}_{i} \vert target located in {c}_{i} \} = 1 - exp [ - κ ( {c}_{i} , {c}_{j} , τ ) ] , \qquad Eq . B2$$

where κ(cᵢ, cⱼ, r) is the search effort applied to cell cᵢ when agent 20 is located in cell cⱼ and the observation period is τ. Usually, the search effort κ(cᵢ, cⱼ, r) may be proportional to the ratio of observation period τ to the distance d(cᵢ, cⱼ) between the cells cᵢ and cⱼ, κ(cᵢ, cⱼ, τ)˜τ/d(cᵢ, cⱼ), which represents the assumption that the shorter the distance d(cᵢ, cⱼ) between the agent and the observed cell and the longer the observation period τ, the higher the detection probability is.

To define the possibility of false positive and false negative detection errors, we assume that the occupied cells, the states of which at time t, t=1, 2, . . . , are s(c, t)=1, broadcast an alarm ã(c, t)=1 with probability as in Eq. B3, below:

$${p}_{TA} = Pr \{ \tilde{a} ( c , t ) = 1 \vert s ( c , t ) = 1 \} \qquad Eq . B3$$

The empty cells, the states of which at time t, t=1, 2, . . . , are s(c, t)=0, broadcast the alarm d(c, t)=1 with probability as in Eq. B4, below:

$${p}_{FA} = Pr \{ \tilde{a} ( c , t ) = 1 \vert s ( c , t ) = 0 \} = α {p}_{TA} \qquad Eq . B4$$

where 0≤α<1. The first alarm may be called a true alarm, and the second alarm may be called a false alarm.

By the Koopman formula, the probability of perceiving the alarms may be as in Eq. B5, below:

$$Pr \{ alarm percieved at {c}_{j} \vert alarm sent from {c}_{i} \} = exp [ - d ( {c}_{i} , {c}_{j} ) / λ ] \qquad Eq . B5$$

where λ is the sensitivity of the sensor installed on the agent; it is assumed that all the cells may be observed during the same period, so the value τ can be omitted.

Denote by pᵢ(t)=Pr{s(cᵢ, t)=1} the probability that at time t, cell cᵢ is occupied by the target, that is, its state is s(cᵢ, t)=1. The vector P(t)={p₁(t), p₂(t), . . . , pₙ(t)} of probabilities 240PV pᵢ(t), i=1, 2, . . . , n, also called the probability map of the domain, may represent the agent's knowledge about the targets' locations in the cells cᵢ∈C, i=1, 2, . . . , n, at time t.

Then, the probability of the event \tilde{x}ⱼ(cᵢ, t), i, j=1, 2, . . . , n, that at time t the agent located in cell cⱼ receives a signal from cell cᵢ, may be defined as in Eq. B6 below:

$$Eq . B6$$

$$p ( {\tilde{x}}_{j} ( {c}_{i} , t ) ) = {p}_{i} ( t - 1 ) {p}_{TA} exp [ - d ( {c}_{i} , {c}_{j} ) / λ ] + ( 1 - {p}_{i} ( t - 1 ) ) {p}_{FA} exp [ - d ( {c}_{i} , {c}_{j} ) / λ ]$$

The probability of the event \overline{\tilde{x}ⱼ(cᵢ, t)}, that this agent does not receive a signal at time t, may be as in Eq. B7 below:

$$Eq . B7$$

$$p ( \overline{{\tilde{x}}_{J} ( {c}_{ι} , t )} ) = 1 - p ( {\tilde{x}}_{j} ( {c}_{i} , t ) )$$

Note that the event \tilde{x}ⱼ(cᵢ, t) may represent the fact that the agent 20 does not distinguish between true and false alarms, but it indicates that the agent 20 receives a signal (which can be either a true or false alarm) from cell cᵢ. If α=1 and therefore p_{TA}=p_{FA}, we may arrive at Eq. B8, below:

$$Eq . B8$$

$$p ( {\tilde{x}}_{j} ( {c}_{i} , t ) ) = {p}_{TA} exp [ - d ( {c}_{i} , {c}_{j} ) / λ ]$$

which means that the agent's knowledge about the targets' locations does not depend on the probability map.

When the agent located in cell cⱼ receives a signal from cell cᵢ, the probability that cell cᵢ is occupied by the target may be as in Eq. B9, below:

$$Eq . B9$$

$$Pr \{ s ( {c}_{i} , t ) = 1 \vert {\tilde{x}}_{j} ( {c}_{i} , t ) \} = \frac{{p}_{i} ( t - 1 ) Pr \{ {\tilde{x}}_{j} ( {c}_{i} , t ) \vert s ( {c}_{i} , t ) = 1 \}}{\begin{matrix}{p}_{i} ( t - 1 ) Pr \{ {\tilde{x}}_{j} ( {c}_{i} , t ) \vert s ( {c}_{i} , t ) = 1 \} + \\ ( 1 - {p}_{i} ( t - 1 ) ) Pr \{ {\tilde{x}}_{j} ( {c}_{i} , t ) \vert s ( {c}_{i} , t ) = 0 \}\end{matrix}} ,$$

and the probability that cᵢ is occupied by the target when the agent does not receive a signal from cᵢ may be as in Eq. B10, below:

$$Eq . B10$$

$$Pr \{ s ( {c}_{i} , t ) = 1 \vert \overline{{\tilde{x}}_{J} ( {c}_{ι} , t )} \} = \frac{{p}_{i} ( t - 1 ) Pr \{ \overline{{\tilde{x}}_{J} ( {c}_{ι} , t )} \vert s ( {c}_{i} , t ) = 1 \}}{\begin{matrix}{p}_{i} ( t - 1 ) Pr \{ \overline{{\tilde{x}}_{J} ( {c}_{ι} , t )} \vert s ( {c}_{i} , t ) = 1 \} + \\ ( 1 - {p}_{i} ( t - 1 ) ) Pr \{ \overline{{\tilde{x}}_{J} ( {c}_{ι} , t )} \vert s ( {c}_{i} , t ) = 0 \}\end{matrix}} ,$$

where the probabilities 240PV pᵢ(t−1), i=1, 2, . . . , n, represent the agent's knowledge about the targets' locations at time t−1 and it is assumed that the initial probabilities 240PV pᵢ(0) at time t=0 are defined with respect to prior information; if there is any initial information about the targets' locations, it is assumed that

$${p}_{i} ( 0 ) = \frac{1}{2}$$

for each i=1, 2, . . . , n.

In the framework of the Koopman approach, these probabilities 240PV may be defined on the basis of Eq. B6 and Eq. B7, and may be represented as in Eqs. B11, and B12 below:

$$Eq . B11$$

$$Pr \{ s ( {c}_{i} , t ) = 1 \vert {\tilde{x}}_{j} ( {c}_{i} , t ) \} = \frac{{p}_{i} ( t - 1 ) {p}_{TA}}{{p}_{i} ( t - 1 ) {p}_{TA} + ( 1 - {p}_{i} ( t - 1 ) ) α {p}_{TA}} ,$$

$$Eq . B12$$

$$Pr \{ s ( {c}_{i} , t ) = 1 \vert \overline{{\tilde{x}}_{J} ( {c}_{ι} , t )} \} = \frac{{p}_{i} ( t - 1 ) ( 1 - {p}_{TA} exp [ - d ( {c}_{i} , {c}_{j} ) / λ ] )}{\begin{matrix}{p}_{i} ( t - 1 ) ( 1 - {p}_{TA} exp [ - d ( {c}_{i} , {c}_{j} ) / λ ] ) + \\ ( 1 - {p}_{i} ( t - 1 ) ) ( 1 - α {p}_{TA} exp [ - d ( {c}_{i} , {c}_{j} ) / λ ] )\end{matrix}} .$$

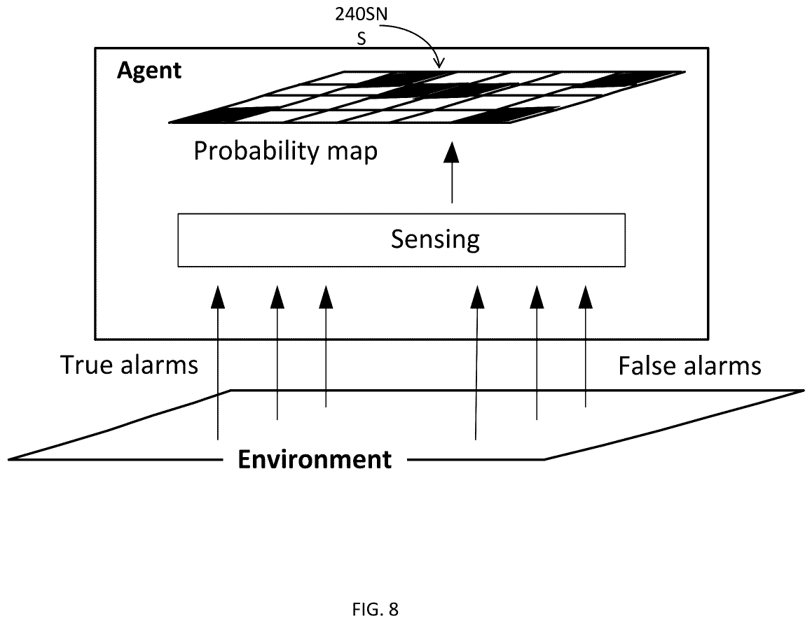

FIG. 8 is a schematic diagram depicting a process of receiving information and updating probability map 240SNS according to some embodiments of the invention.

As illustrated in FIG. 8, the agent 20 may receive true and false alarms through its on-board sensors, and based on this information, agent 20 may update the targets' location probabilities 240PV in map 240 with equations Eq. B11 and Eq. B12.

In the case of static targets, the location probabilities 240PV pᵢ(t), i=1, 2, . . . , n, may depend only on the agent's location at time t and its movements, while in the case of moving targets, these probabilities 240PV may be defined both by the targets' and by the agent's activities. In the considered problem, it is assumed that the targets act independently on the agent's motion, while the agent may be aware of the process that governs the targets' motion.

In general, the process of target detection may be outlined as follows. At each step, the agent may consider the probabilities 240PV pᵢ(t), i=1, 2, . . . , n, for the targets' locations and may perform a decision regarding its next action (e.g., movement).

After moving to the new location (or remaining at its current location), the agent may receive signals from the available cells, and may update the probabilities 240PV pᵢ(t) following equations Eq. B11 and Eq. B12. The obtained updated probabilities 240PV pᵢ(t+1) may be used to continue the process.

Embodiments of the invention may define the motion of the agent that results in the detection of all targets in minimal time. As indicated above, in detecting the targets, the agent may not be required to arrive to their exact locations, but rather required to specify the locations as definitively as possible. Since finding a general definition of the optimal agent's motion for any nontrivial scenario may be computationally intractable, the inventors searched for a practically computable, near-optimal solution.

### Decision-Making Policy and Deep Q-Learning Solution

Formally, the detection problem of interest may be specified as follows. Starting from the initial cell c(0), at time t, the agent is located in cell c(t) and determines its action [symbol] (t): C→C that determines to which cell c(t+1) the agent should move from its current location c(t).

### The Agent's Actions and Decision Making

We assume that the policy π: C×P→ [symbol] for choosing an action does not depend on time and is specified for any t by the current agent's location c(t) and probability map P(t). Then, the desired policy should produce actions such that the agent's trajectory from the cell c(0) up to the final cell c(T) is as short as possible (in the sense that the termination time T is as short as possible), and that by following this trajectory, the agent detects all 5 targets. It is assumed that the number ξ of targets may not be available to the agent during detection and may be used to indicate the end of the detection process.

With respect to the indicated properties of the desired agent trajectory, a search for the decision-making policy can follow either the maximization of the expected cumulative information gain over the trajectory or the direct optimization of the length of the trajectory in the indicated sense of minimal detection time. The first approach may be referred to as the Q-max algorithm, and the second may be referred to as the SPL algorithm.

Currently available systems may perform detection problem by evaluating the decisions made at each step of the search and detection process. In one algorithm, the agent may follow the maximal Expected Information Gain (EIG) over the cells that are reachable in a single step from the agent's current location. In a second algorithm, the agent may move one step toward the maximal expected information gain over all the cells, which may be the Center Of View (COV) of the domain. In a third algorithm, the agent may move toward the center of the distribution or the Center Of Gravity (COG) with respect to the current probability map.

Embodiments of the invention may address a more sophisticated approach that implements deep Q-learning techniques. For example, embodiments may consider the information-based Q-max algorithm and then the SPL algorithm.

Let us start with the Q-max solution of the considered detection problem. Assume that at each time t the agent may be located in cell c(t) and action [symbol] (t) may be chosen from among the possible movements from cell c(t), which are to step “forward”, “right-forward”, “right”, “right-backward”, “backward”, “left-backward”, “left”, or “left-forward” or “stay in the current cell”. Symbolically, we write this choice as in Eq. B13, below:

$$Eq . B13$$

$$𝕒 ( t ) ∈ 𝔸 = \{ ↑ , ↗ , \to , ↘ , ↓ , ↙ , ← , ↖ , ⊙ \} .$$

Denote by [symbol] (t+1) a probability map that should represent the targets' locations at time t+1 given that at time t, the agent chooses action [symbol] (t). Then, given action [symbol] , the immediate expected informational reward 240R (‘R’) of the agent may be defined as in Eq. B14, below:

$$Eq . B14$$

$$R ( 𝕒 , t ) = {D}_{KL} ( {P}_{𝕒} ( t + 1 ) \vert \vert P ( t ) ) ,$$

that is, the Kullback-Leibler distance between the map [symbol] (t+1) and the current probability map P(t).

Given a policy π for choosing an action, the expected cumulative discounted reward q_{π} 250Q obtained by an agent that starts in cell c(t) with probability map P(t) and chooses action [symbol] (t) may be calculated as in Eq. B15 below:

$$Eq . B15$$

$${q}_{π} ( c ( t ) , P ( t ) , 𝕒 ( t ) ) = {𝔼}_{π} \{ {\sum }_{τ = 0}^{∞} {γ}^{τ} R ( 𝕒 , t + τ ) \} ,$$

where the discount factor may be 0<γ≤1, and the goal may be to find a maximum value as in Eq. B16 below:

$$Eq . B16$$

$$Q ( c ( t ) , P ( t ) , 𝕒 ( t ) ) = {max}_{π} {q}_{π} ( c ( t ) , P ( t ) , 𝕒 ( t ) )$$

of the expected reward q_{π} 250Q over all possible policies π that can be applied after action [symbol] (t) is chosen at time t.

Since the number of possible policies may be infinite, the value Q(c(t), P(t), [symbol] (t)) 250Q of the maximal expected cumulative discounted reward cannot be calculated exactly, and for any realistic scenario, it should be approximated. Below, the inventors follow the deep Q-learning approach and present the Q-max algorithm, which approximates the values Q(c(t), P(t), [symbol] (t)) 250Q of the reward for all possible actions (13) and therefore provides criteria for choosing the actions.

Dynamic Programming Scheme with Prediction and Target Neural Networks

The learning stage in the suggested Q-max algorithm may be based on a neural network 250 with dynamic programming for predicting current rewards 240R. In a simple, exemplary configuration, which may still be effective, neural network 250 may consist of one input layer, which includes 2n neurons (recall that n may be the size of the domain); one hidden layer, which also includes 2n neurons; and an output layer, which includes # [symbol] =9 neurons with respect to the number of possible actions.

An example of the neural network 250 scheme used in the learning stage of the Q-max algorithm is shown in FIG. 5.

The inputs of network 250 may be as follows. A first chunk of n inputs (1, 2, . . . n) may receive a vector [c₁ . . . cₙ] that represents the agent(s) locations 30A/30B. For example, vector [cᵢ . . . cₙ] may be a binary vector, where if the agent is located in cell cⱼ, then the jth input of the network is equal to 1 and the other n−1 inputs are equal to 0.

Additionally, or alternatively, vector [c₁ . . . cₙ]30A/30B may be a trinary vector, where if the agent 20 of network 250 is located in cell cⱼ, then the jth input of the network is equal to a first value (e.g., 2), if another agent 20 is located in cell cⱼ, then the jth input of the network is equal to a second value (e.g., 1), and all other inputs of vector [c₁ . . . cₙ] may be equal to a third value (e.g., 0).

The second chunk of n inputs (n+1, n+2, . . . 2n) may receive the target location probabilities 240PV; namely, the (n+i)th input receives the target location probability pᵢ, i=1, 2, . . . , n, as it appears in the probability map P.

The hidden layer of network 250 may consist of 2n neurons, each of which implements a fully connected linear layer and sigmoid activation function ƒ(x)=1/(1+e^{-x}). The inventors have chosen this activation function from among several possible activation functions, such as the step function, Softplus function and SiLU function, and it was found that it provides adequate learning in all conducted simulations.

The output layer of neural network 250 may include nine neurons, corresponding to the possible actions. Namely, the first output corresponds to the action [symbol] =“↑”, “step forward”; the second output corresponds to the action [symbol] =“ [symbol] ”, “step right-forward”; and so on. Action [symbol] =“⊙” represents a “non-action”, e.g., where agent 20 is to stay in the current cell. The value of the kth output may be the maximal expected cumulative discounted reward Q(cⱼ, P, [symbol] ) obtained by the agent if it is in cell cⱼ, j=1, 2, . . . , n, and given the target location probabilities 240PV P=(p₁, p₂, . . . , pₙ), it chooses action [symbol] , k=1, 2, . . . , 9.

The training stage of neural network 250 may implement deep Q-learning techniques, which follow the dynamic programming approach. In general, the Bellman equation for calculating the maximal cumulative discounted reward 250Q (‘Q’) may be provided as equation Eq. B17 below:

$$Eq . B17$$

$$Q ( c ( t ) , P ( t ) , 𝕒 ( t ) ) = R ( 𝕒 , t ) + γ {max}_{𝕒 ∈ 𝔸} Q ( c ( t + 1 ) , P ( t + 1 ) , 𝕒 )$$

and this equation forms a basis for updating the weights of the links in the network.

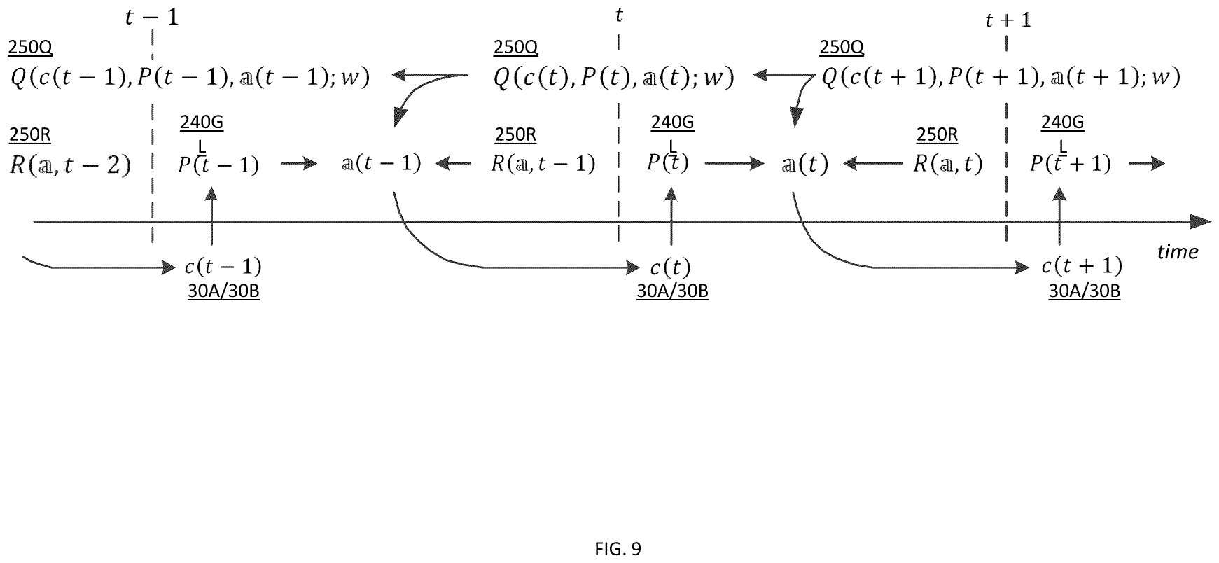

Reference is now made to FIG. 9 which is a schematic diagram depicting a scheme of data flow in a training stage of neural network 250, according to some embodiments of the invention. According to some embodiments, FIG. 9 depicts an example of data flow as specified by equation Eq. B17.

Let w be a vector of the link weights 250W of network 250. In this example, there are 4n²+18n+2n+9 values of the weights, where 4n² is the number of links between the input layers and the hidden layer, 18n is the number of links between the hidden layer and the output layer, 2n is the number of biases in the hidden layer and 9 is the number of biases in the output layer.

In addition, to distinguish these steps and to separate them from the real time, the inventors have enumerated the training steps by l=1, 2, . . . below and retain the symbol t for the real-time moments of the detection process.

Denote by Q(c(l), P(l), [symbol] (l); w) the maximal cumulative discounted reward calculated at step l=1, 2, . . . by the network with weights w 250W, and denote by Q⁺(c(l), P(l), [symbol] (l); w′) the expected maximal cumulative discounted reward 250Q calculated using the vector w′ of the updated weights 250W following the recurrent equation Eq. B17; as in equation Eq. B18, below:

$$Eq . B18$$

$${Q}^{+} ( c ( l ) , P ( l ) , 𝕒 ( l ) ; {w}^{′} ) = R ( 𝕒 , l ) + γ {max}_{𝕒 ∈ 𝔸} Q ( c ( l + 1 ) , P ( l + 1 ) , 𝕒 ; {w}^{′} )$$

Then, the temporal difference learning error may be provided by equation Eq. B19, below:

$$Eq . B19$$

$${Δ}_{l} ( Q ) = {Q}^{+} ( c ( l ) , P ( l ) , 𝕒 ( l ) ; {w}^{′} ) - Q ( c ( l ) , P ( l ) , 𝕒 ( l ) ; w ) .$$

According to some embodiments, the values Q(c(l), P(l), [symbol] (l); w) and Q⁺(c(l), P(l), [symbol] (l); w′) may be associated with separate neural networks; the first may be called the prediction network, and the second is called the target network.

Additionally, or alternatively, prediction network, and target network may be implemented as the same neural network 250 model or instance, but represent different phases of operation:

Prediction network 250 may be configured to predict PCR (Q) values 250Q pertaining to each optional action a. In other words, prediction network 250 may select an optimal action a, that would produce a maximal cumulative future reward, e.g., a most elaborated global probability map 240GL (P), from all participating agents. The term elaborated may be used in this context to refer to a map 240GL having the maximal number of targets, and/or representing targets with a maximal confidence level at least one target.

Additionally, or alternatively, target network 250 may be configured to obtain the immediate reward 250R (‘R’) following movement of agent 20, and recalculate PCR (Q) values 250Q, to obtain a temporal difference learning error Δₗ(Q), which may be introduced as feedback to train prediction network 250.

### Model-Free and Model-Based Learning

The updating of the weights w in the prediction network may be conducted by following basic backpropagation techniques; namely, the weights for the next step l+1 may be updated with respect to the temporal difference learning error Δₗ(Q) calculated at the current step l. The weights w′ in the target network may be updated to the values of the weights w after an arbitrary number of iterations. In the simulations presented in subsequent sections, such updating was conducted at every fifth step.

The presented training procedure directly uses the events occurring in the environment and may not require prior knowledge about the targets' abilities. In other words, by following this procedure, agent 20 may detect the targets in the environment, and simultaneously learn the environment and train neural network 250 that supports the agent's 20 decision-making processes. We refer to such a scenario as model-free learning.

The actions of the online model-free learning procedure of the Q-max algorithm are illustrated in FIG. 6.

Following the figure, at step l, the target location probabilities 240PV Pr{s(cᵢ, l)=1|\tilde{x}ⱼ(cᵢ, l)} and Pr{s(cᵢ, l)=1|\overline{\tilde{x}ⱼ(cᵢ, l)}}, i, j=1, 2, . . . , n, may be updated according to equations E-11 and E-12 with respect to the events \tilde{x}ⱼ(cᵢ, l) and \overline{\tilde{x}ⱼ(c, l)} of receiving and not receiving a signal from cell cᵢ while the agent is in cell cⱼ. The updated target location probabilities 240PV may be used for calculating the value of the immediate reward 240R R( [symbol] , l) by equation E-14 and the value Q⁺(c(l), P(l), [symbol] (l); w′) by equation E-18 in the target network. In parallel, the value Q(c(l), P(l), [symbol] (l); w) of the prediction network may be used for choosing the action and consequently for specifying the expected position of the agent in the environment. After calculating the temporal difference error Δₗ(Q) between the Q-values in the target and in the prediction network by equation E-19, the weights w in the prediction network may be updated, and the process continues with step l+1.

Note that in all the above definitions, the cumulative reward 250Q does not depend on the previous trajectory of the agent. Hence, the process that governs the agent's activity may be a Markov process with states that include the positions of the agent and the corresponding probability maps. This property allows the use of an additional offline learning procedure based on the knowledge of the targets' abilities.

Namely, if the abilities of the targets are known and can be represented in the form of transition probability matrices that govern the targets' motion, the learning process can be conducted offline without checking the events occurring in the environment. In this scenario, at step l, instead of the target location probabilities 240PV Pr{s(cᵢ, l)=1|\tilde{x}ⱼ(cᵢ, l)} and Pr{s(cᵢ, l)=1|\overline{\tilde{x}ⱼ(cᵢ, l)}}, i, j=1, 2, . . . , n, the networks use the probabilities 240PV of the expected targets' locations Pr{s(cᵢ, l)=1|s(cᵢ, l−1)=1} and Pr{s(cᵢ, l)=1|s(cᵢ, l−1)=0} at step l given the states of the cells at the previous step l−1.

Based on the previous definitions, these probabilities may be defined as in Eqs. B20 and B21, below:

$$Eq . B 20$$

$$Pr \{ s ( {c}_{i} , l ) = 1 \vert s ( {c}_{i} , l - 1 ) = 1 \} = \frac{{p}_{i} ( l - 1 ) {p}_{TA} exp [ - d ( {c}_{i} , {c}_{j} ) / λ ]}{{p}_{i} ( l - 1 ) ( 1 - α ) + α} + \frac{{p}_{i} ( l - 1 ) {( 1 - exp [ - d ( {c}_{i} , {c}_{j} ) / λ ] )}^{2}}{\begin{matrix}{p}_{i} ( l - 1 ) ( 1 - {p}_{TA} exp [ - d ( {c}_{i} , {c}_{j} ) / λ ] ) + \\ ( 1 - {p}_{i} ( l - 1 ) ) ( 1 - α {p}_{TA} exp [ - d ( {c}_{i} , {c}_{j} ) / λ ] )\end{matrix}} ,$$

$$Eq . B 21$$

$$Pr \{ s ( {c}_{i} , l ) = 1 \vert s ( {c}_{i} , l - 1 ) = 0 \} = \frac{{p}_{i} ( l - 1 ) α {p}_{TA} exp [ - d ( {c}_{i} , {c}_{j} ) / λ ]}{{p}_{i} ( l - 1 ) ( 1 - α ) + α} + \frac{\begin{matrix}{p}_{i} ( l - 1 ) ( 1 - exp [ - d ( {c}_{i} , {c}_{j} ) / λ ] ) \\ ( 1 - α {p}_{TA} exp [ - d ( {c}_{i} , {c}_{j} ) / λ ] )\end{matrix}}{\begin{matrix}{p}_{i} ( l - 1 ) ( 1 - {p}_{TA} exp [ - d ( {c}_{i} , {c}_{j} ) / λ ] ) + \\ ( 1 - {p}_{i} ( l - 1 ) ) ( 1 - α {p}_{TA} exp [ - d ( {c}_{i} , {c}_{j} ) / λ ] )\end{matrix}} .$$

Since the presented procedure may be based on certain knowledge about the targets' activity, it is called the model-based learning procedure.

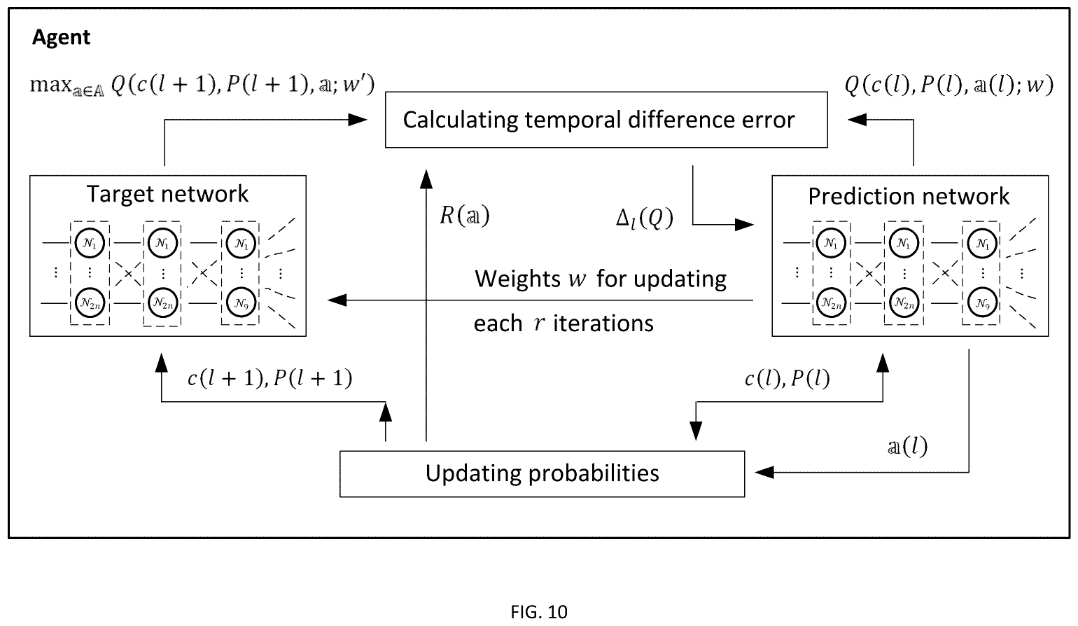

Reference is now made to FIG. 10 which is a schematic diagram depicting the actions of the offline model-based learning procedure of the Q-max algorithm, according to some embodiments of the invention.

The model-based learning procedure may differ from the model-free learning procedure in the use of the target location probabilities and the method of updating them. In the model-free procedure, these probabilities may be specified based on the events occurring in the environment. In the model-free procedure, they may be calculated by following the Markov property of the system without referring to the real events in the environment.

As a result, in the model-free procedure, the learning may be slower than in the model-based procedure. However, while in the first case, the agent learns during the detection process and can act without any prior information about the targets' abilities, in the second case, it starts detection only after offline learning and requires an exact model of the targets' activity. Thus, the choice of a particular procedure may be based on the considered practical task and available information.

### The Choice of the Actions at the Learning Stage

As indicated above, given the agent's location c(l) and the targets' probability map P(l), the neural networks used at the learning stage provide nine output Q-values that are associated with possible actions [symbol] ∈ [symbol] , k=1, 2, . . . , 9, as in equation Eq. B22, below:

$$Eq . B 22$$

$$Q ( c ( l ) , P ( l ) , {𝕒}_{1} ; w ) , Q ( c ( l ) , P ( l ) , {𝕒}_{2} ; w ) , … , Q ( c ( l ) , P ( l ) , {𝕒}_{9} ; w )$$

where [symbol] =“↑” (“step forward”), [symbol] =“ [symbol] ” (“step right-forward”), and so on up to [symbol] =“⊙” (“stay in the current cell”).

The choice among the actions [symbol] ∈ [symbol] may be based on the corresponding Q-values Q(c(l), P(l), [symbol] ; w), k=1, 2, . . . , 9, and implements exploration and exploitation techniques. At an initial step l=0, when the agent has no prior learned information about the targets' locations, action [symbol] (l)∈ [symbol] may be chosen randomly. Then, after processing the step prescribed by action [symbol] (l), the next action [symbol] (l+1) may be chosen either on the basis of the target location probabilities 240PV learned by the neural networks or randomly from among the actions available at this step. The ratio of random choices decreases with the number of steps, and after finalizing the learning processes in the neural networks, the actions may be chosen with respect to the Q-values only.

Formally, this process can be defined using different policies, for example, with a decaying E-greedy policy that uses the probability ϵ, which decreases with the increase in the number of steps from its maximal value ϵ=1 to the minimal value ϵ=0. The agent chooses an action randomly with probability ϵ and according to the greedy rule

$$arg {max}_{𝕒 ∈ 𝔸} Q ( c ( l ) , P ( l ) , 𝕒 ; w )$$

with probability 1−ϵ. In this policy, the choice of the action may be governed by the probability ϵ and does not depend on the Q-values of the actions.

A more sophisticated policy of intermittence between random and greedy choice may be the SoftMax policy. In this policy, the probability p( [symbol] |Q; η) of choosing action [symbol] may be defined with respect to both the parameter η∈[0, +∞) and the Q-values of the actions, as in equation B22, below:

$$Eq . B 22$$

$$p ( {𝕒}_{k} \vert Q ; η ) = \frac{exp [ Q ( c ( l ) , P ( l ) , {𝕒}_{k} ; w ) / η ]}{{\sum }_{j = 1}^{9} exp [ Q ( c ( l ) , P ( l ) , {𝕒}_{j} ; w ) / η ]} .$$

Therefore, if η→0, then

$$p ( {𝕒}_{k} \vert Q ; η ) \to 1 for {𝕒}_{k} = arg {max}_{𝕒 ∈ 𝔸} Q ( c ( l ) , P ( l ) , 𝕒 ; w )$$

and p( [symbol] |Q; η)→0 for all other actions, and if η→∞, then

$$p ( {𝕒}_{k} \vert Q ; η ) \to \frac{1}{9} ,$$

which corresponds to a randomly chosen action. The intermediate values 0<η<∞ correspond to the probabilities p( [symbol] |Q; η)∈(0,1) and govern the randomness of the action choice. In other words, the value of the parameter η decreases with the increasing number of steps l from its maximal value to zero; thus, for the unlearned networks, the agent chooses actions randomly and then follows the information about the targets' locations learned by the networks. The first stages with randomly chosen actions may be interpreted as exploration stages, and the later stages based on the learned information may be considered exploitation stages. In the simulations, we considered both policies and finally implemented the SoftMax policy since it provides more correct choices, especially in cases with relatively high Q-values associated with different actions.

### Outline of the Q-Max Algorithm

Recall that according to the formulation of the detection problem, the agent acts in the finite two-dimensional domain C={c₁, C₂, . . . , cₙ} and moves over this domain with the aim of detecting ξ≤n−1 hidden targets. At time t=0, 1, 2, . . . in cell c(t)∈C, the agent observes the domain (or, more precisely, screens the domain with the available sensors) and creates the probability map P(t)={p₁(t), p₂(t), . . . , pₙ(t)}, where pᵢ(t) may be the probability that at time t, cell cᵢ may be occupied by a target, i=1, 2, . . . , n. Based on the probability map P(t), the agent chooses an action [symbol] (t)∈ [symbol] . By processing the chosen action [symbol] (t), the agent moves to the next cell c(t+1), and this process continues until the targets' locations are detected. The agent's goal may be to find a policy of choosing the action that provides the fastest possible detection of all the targets with a predefined accuracy.

In contrast to the recently suggested algorithms, which directly implement one-step decision making, the presented novel algorithm includes learning processes and can be used both with model-free learning for direct online detection and with model-based learning for offline policy planning and further online applications of this policy. Since both learning processes follow the same steps (with the only difference being in the source of information regarding the targets' location probabilities 240PV), below, we outline the Q-max algorithm with model-based learning.

The Q-max algorithm with model-based learning includes three stages: in the first stage, the algorithm generates the training data set, which includes reasonable probability maps with possible agent locations; in the second stage, it trains the prediction neural network using the generated data set; and in the third stage, the algorithm solves the detection problem by following the decisions made by the trained prediction neural network.

Algorithm 1 outlines the first stage that is generating of the training data set:

Algorithm 1. Generating the training data set

Input: domain C = {c₁, c₂, ... , cₙ},

set [symbol] = {↑, [symbol] , →, [symbol] , ↓, [symbol] , ←, [symbol] ,⊙} of possible actions,
probability p_{TA} of true alarms (Equation (3)),
rate α of false alarms and their probability p_{FA} = αp_{TA} (Equation (4)),
sensor sensitivity λ,
range [ξ₁, ξ₂] of possible numbers 0 < ξ₁ < ξ₂ ≤ n − 1 of targets,
length L ∈ (0, ∞) of the agent's trajectory,
number N ∈ (0, ∞) of agent trajectories,
initial probability map P(0) on the domain C.

Output: data set that is an L × N table of pairs (c, P) of agent positions c and
corresponding probability maps P.

| | |
|---|---|
| 1. | Create the L × N data table. |
| 2. | For each agent trajectory j = 1, ... , N do: |
| 3. | Choose a number ξ ∈ [ξ₁, ξ₂] of targets according to a uniform distribution on the |
| | interval [ξ₁, ξ₂]. |
| 4. | Choose the target locations c₁, c₂, ... , c_{ξ} ∈ C randomly according to the uniform |
| | distribution on the domain C. |
| 5. | Choose the initial agent position c(0) ∈ C randomly according to the uniform |
| | distribution on the domain C. |
| 6. | For l = 0, ... , L − 1 do: |
| 7. | Save the pair [symbol] c(l), P(l) [symbol] as the jth element of the data table. |
| 8. | Choose an action [symbol] (l) ∈ [symbol] randomly according to the uniform distribution on the |
| | set [symbol] . |
| 9. | Apply the chosen action and set the next position c(l + 1) = [symbol] (c(l)) of the |
| | agent. |
| 10. | Calculate the next probability map P(l + 1) with Equations (20) and (21). |
| 11. | End for |
| 12. | End for |
| 13. | Return the data table. |

The data training data set may include N random trajectories of length L. Each element of the data set may be a pair of an agent position and a probability map.

In some embodiments, the reason for generating the data instead of drawing it randomly may be that the training data set may be used at the learning stage of the prediction network, so it should represent the data in as realistic a form as possible. Since in the generated data set, the agent's positions may be taken from the connected trajectory and the corresponding probability maps may be calculated with respect to these positions, possible actions, sensing abilities and environmental conditions, it can be considered a good imitation of real data.

The generated agent positions and corresponding probability maps may be used as an input of the prediction neural network in the training stage. The goal of the training may be specified by the objective probability map P*={p₁*, p₂*, . . . , pₙ*}, which defines the target location probabilities 240PV that provide sufficient information for the immediate detection of all the targets. In the best case, we have probabilities pᵢ*∈{0,1}, and in practical scenarios, it may be assumed that either pᵢ*∈[0, ε] or pᵢ*∈[1−ε, 1] for certain 0<ε<<1, i=1, 2, . . . , n.

The training stage of the Q-max algorithm may be implemented in the form of Algorithm 2, which is outlined below (the scheme of the learning procedure is shown in FIG. 10).

Algorithm 2. Training the prediction neural network

```
Network structure:
  input layer: 2n neurons (n agent positions and n target location probabilities,
  both relative to the size n of the domain),
  hidden layer: 2n neurons,
  output layer: 9 neurons (in accordance with the number of possible actions).
Activation function:
  sigmoid function f(x) = 1/(1 + e^{-x}).
Loss function:
  mean square error (MSE) function.
Input: domain C = {c₁, c₂, ... , cₙ},
  set [symbol]  = {↑, [symbol] , →, [symbol]  , ↓, [symbol] , ←, [symbol] , ⊙} of possible actions,
  probability P_{TA} of true alarms (Equation (3)),
  rate α of false alarms and their probability p_{FA} = αp_{TA} (Equation (4)),
  sensor sensitivity λ,
  discount factor γ,
  objective probability map P* (obtained by using the value ε),
  number r of iterations for updating the weights,
  initial value η (Equation (22)) and its discount factor δ,
  learning rate ρ (with respect to the type of optimizer),
  number M of epochs,
  initial weights w of the prediction network and initial weights w′ = w of the
  target network,
  training data set (that is, the L × N table of (c, P) pairs created by Procedure 1).
Output: The trained prediction network.
  1. Create the prediction network.
  2. Create the target network as a copy of the prediction network.
  3. For each epoch j = 1, ... , M do:
  4. For each pair (c, P) from the training data set, do:
  5. For each action [symbol]    ∈ [symbol]  do:
  6. Calculate the value Q(c, P, [symbol]   ; w) with the prediction network.
  7. Calculate the probability p( [symbol]  |Q; η) (Equation (22)).
  8. End for.
  9. Choose an action according to the probabilities p( [symbol]  |Q; η).
10. Apply the chosen action and set the next position c′ = [symbol]   (c) of the agent.
11. Calculate the next probability map P′ with Equations (20) and (21).
12. If P = P* or c′ ∉ C, then
13. Set the immediate reward R( [symbol]  ) = 0.
14. Else
15. Calculate the immediate reward R( [symbol]  ) with respect to P and P′ (Equation (14)).
16. End if.
17. For each action [symbol]    ∈ [symbol]  do:
18. If P = P* then
19. Set Q(c′, P′, [symbol]   ; w′) = 0.
20. Else
21. Calculate the value Q(c′, P′, [symbol]   ; w′) with the target network.
22. End if.
23. End for.
$24. Calculate the target value {Q}^{+} = R ( 𝕒 ) + γ {max}_{𝕒 ∈ 𝔸} Q ( {c}^{′} , {P}^{′} , 𝕒 ; {w}^{′} ) ( Equation 17 ) ) .$
25. Calculate the temporal difference learning error as Δₗ(Q) = Q⁺ − Q(c, P, [symbol]   ; w)
    for the chosen action a (Equation (19)) and set Δₗ(Q) = 0 for all other actions.
26. Update the weights w in the prediction network by backpropagation with respect
    to the error Δₗ(Q).
27. Every r iterations, set the weights of the target network as w' = w.
28. End for.
```

The inventors have validated network 250 on a validation data set that includes the pairs (c, P), which may be similar to the pairs appearing in the training data set but were not used in the training procedure; the size of the validation data set may be approximately ten percent of the size of the training data set.

After training, the Q-max algorithm can be applied to simulated data or in a real search over a domain. It is clear that the structure of the algorithm mimics the search conducted by rescue and military services: first, the algorithm learns the environment (by itself or at least by using the model) and then continues with the search in the real environment, where the probability map may be updated with respect to the received alarms and acquired events (Equations E-11 and E-12) and decision-making may be conducted using the prediction network.

### The SPL Algorithm

Now let us consider the SPL algorithm. Formally, it may follow the same ideas and may implement the same approach as the Q-max algorithm, but it differs in the definition of the goal function. In the SPL algorithm, a goal function may directly represent the aim of the agent to detect all the targets in a minimal number of steps or to take a minimal number of actions before reaching the termination condition.

In parallel to the reward 240R R ( [symbol] , t) defined by Equation (14) for action [symbol] ∈ [symbol] conducted at time t, we define the penalty, or the price paid by the agent for action [symbol] ∈ [symbol] at time t. In the case of the shortest path length, the payoff represents the steps of the agent; that is, O( [symbol] , t)=1, for each time t=1, 2, . . . until termination of the search. Note again that even if agent 20 chooses to stay at its current position, the payoff is calculated as 1.

Then, given a policy π for choosing an action, the expected cumulative payoff of an agent that starts in cell c(t) with probability map P(t) and chooses action [symbol] (t) as in equation Eq. B23, below:

$$Eq . B 23$$

$${pl}_{π} ( c ( t ) , P ( t ) , 𝕒 ( t ) ) = {𝔼}_{π} \{ {\sum }_{τ = 0}^{∞} O ( 𝕒 , t + τ ) \} ,$$

and the goal may be to find the minimum value as in equation Eq. B24, below:

$$Eq . B 24$$

$$SPL ( c ( t ) , P ( t ) , 𝕒 ( t ) ) = {min}_{π} {pl}_{π} ( c ( t ) , P ( t ) , 𝕒 ( t ) )$$

of the expected payoff pl_{π} over all possible policies if that can be applied after action [symbol] (t) is chosen at time t.

Then, the Bellman equation for calculating the defined minimal expected path length becomes as in Eq. B25, below:

$$Eq . B 25$$

$$SPL ( c ( t ) , P ( t ) , 𝕒 ( t ) ) = O ( 𝕒 , t ) + {min}_{𝕒 ∈ 𝔸} SPL ( c ( t + 1 ) , P ( t + 1 ) , 𝕒 ) ,$$

and the equations that define the training and functionality of the neural networks follow this equation and have the same form as in the Q-max algorithm (with the obvious substitution of maximization by minimization and the use of γ=1).

### Simulation Results

Embodiments of the invention have been implemented and tested in several scenarios. Numerical simulations include training of neural network, simulation of the detection process by Q-max and SPL algorithms and their comparisons with heuristic and optimal solutions.

In the simulations, the detection was conducted over a gridded square domain of size n=nₓ×n_{y} cells, and it was assumed that the agent and each target could occupy only one cell.

### Network Training in the Q-Max Algorithm

First, let us consider the simulation of the network training. The purpose of these simulations is to verify the training method and demonstrate a decrease in the temporal difference learning error Δ(Q) with an increasing number of learning epochs. Since the network training may be the same for both the Q-max and SPL algorithms, we consider the training for the Q-max algorithm.

The training data set was generated using the parameters n=10×10=100, p_{TA}=1, α=0.5, λ=15, ξ₁=1, ξ₂=10, L=50, N=200 and pᵢ(0)=0.05, i=1, 2, . . . , n. The size of the training data set was 10,000.

The input parameters in the simulation used the same values of n=10×10=100, p_{TA}=1, α=0.5, and λ=15, and we also specified γ=0.9 and P* with ε=0.05, r=5, η=100 000, δ=0.99 and ρ=0.001. The number of epochs in the simulation was M=30.

The initial weights w were generated by the corresponding procedures of the PyTorch library. The optimizer used in the simulation was the ADAM optimizer from the PyTorch library.

The average time required for training the prediction neural network was approximately 10 min (on the PC described above), which is a practically reasonable time for an offline procedure. Note that after offline training, online decision-making may be conducted directly by immediate choice without additional calculations.

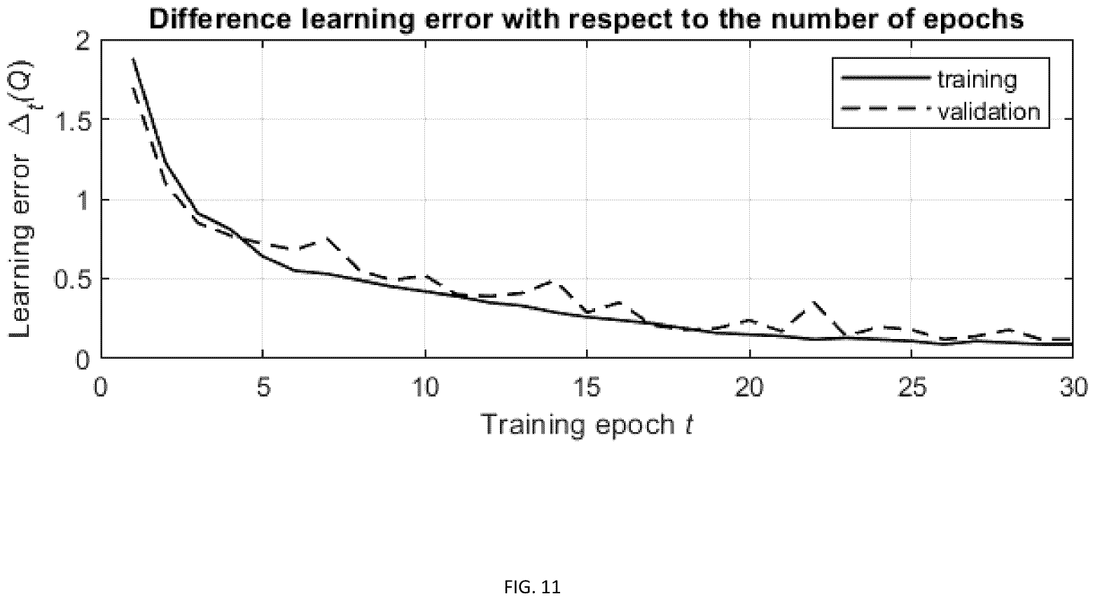

Reference is now made to FIG. 11 which is a graph depicting change in the temporal difference learning error with respect to the number of training epochs, according to some embodiments of the invention. The solid line is associated with the training stage, and the dashed line is associated with the validation stage. The presented graph was obtained by averaging the temporal difference learning errors over 10,000 pairs in the data set.

The temporal difference learning error decreases both in the training stage and in the validation stage of the learning process, and the smoothed graphs for both stages may be exponential graphs with similar rates of decrease. This validates the effectiveness of the learning process and shows that progress in the network training leads to better processing of previously unknown data from the validation data set.

### Detection by the Q-Max and SPL Algorithms

In the next simulations, we considered the detection process with the proposed Q-max and SPL algorithms and compared both algorithms with random detection, which provides the lower bound of the cumulative reward (for the Q-max algorithm) and payoff (for the SPL algorithm).

Both algorithms used the same neural network as above, and the random detection process was initialized with the same parameters as above. However, for better comparison, in the simulations of both algorithms and of random detection, we used the same number of targets ξ=2, which were located at the points (5,0) and (0,9), and the initial position of the agent was c(0)=(9,4). By choosing these positions of the targets and the agent, it is easy to demonstrate (a) the difference between the search processes (in which the agent first moves to the closer target and then to the distant target) and the detection process (in which the agent moves to the point that provides the best observation of both targets) and (b) the motion of the agent over the domain to maximize the immediate reward 240R or minimize the immediate payoff.

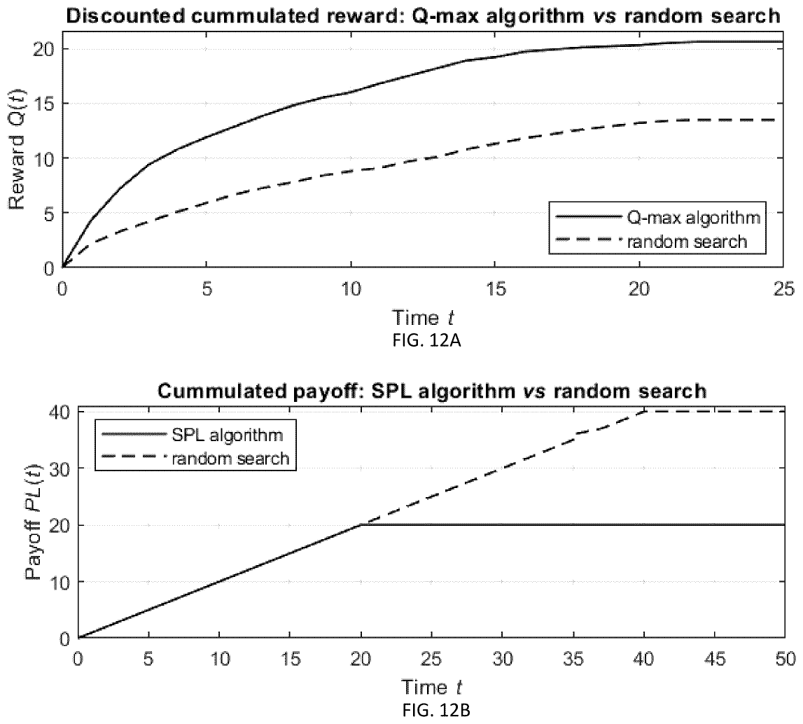

FIG. 12A shows the discounted cumulative reward for the Q-max algorithm in comparison with that of the random detection process, and FIG. 12B shows similar graphs for the SPL algorithm and the random detection process.

FIG. 12A is a graph depicting discounted cumulative reward 250Q of detection by the Q-max algorithm, according to some embodiments of the invention.

FIG. 12A is a graph depicting cumulative payoff of detection by the SPL algorithm compared with the results obtained by the random detection procedure, according to some embodiments of the invention.

The solid line in both figures is associated with the suggested algorithms (Q-max and SPL), and the dashed line is associated with the random choice of actions.

The detection by the proposed algorithms may be much better than the detection by the random procedure. Namely, the Q-max algorithm results in 20.5 units of discounted cumulative reward 250Q, while the random procedure achieves only 13.4 units of discounted reward in the same number of steps. In other words, the Q-max algorithm may be nearly 1.5 times more effective than the random procedure. Similarly, while the random procedure requires 40 steps to detect the targets, the SPL algorithm requires only 20 steps, which means that the SPL algorithm may be 50% better than the random procedure.

From these comparisons, it follows that the suggested algorithms outperform the random procedure in terms of both the informational reward and the agent's path length. However, as follows from the next simulations, the numbers of agent actions up to termination in the Q-max and SPL algorithms may be statistically equal, allowing either algorithm to be applied with respect to the considered practical task.

Comparison between the Q-Max and SPL Algorithms, and the EIG, COV and COG algorithms.

The third set of simulations included comparisons of the suggested Q-max and SPL algorithms with the previously developed heuristic methods, which implement one-step optimization.

The simplest algorithm may be based on the expected information gain, which is an immediate expected information reward 240R (‘R’) as in Eq. B26, below:

$$Eq . B 26$$

$$EIG ( 𝕒 , t ) = R ( 𝕒 , t ) = {D}_{KL} ( {P}_{𝕒} ( t + 1 ) \vert \vert P ( t ) ) ;$$

where (as above) [symbol] (t+1) may stand for the probability map that may be expected to represent the targets' locations at time t+1 given that at time t, the agent chooses action [symbol] (t)∈ [symbol] and P(t) is the current probability map. Then, the next action may be chosen as in Eq. B27, below:

$$Eq . B 27$$

$$𝕒 ( t + 1 ) = arg {max}_{𝕒 ∈ 𝔸} EIG ( 𝕒 , t ) .$$

A more sophisticated algorithm addresses the center of view, which is defined as the cell in which the agent can obtain the maximal expected information gain, as in Eq. B28, below:

$$Eq . B 28$$

$$COV ( t ) = arg {max}_{c ∈ C} {D}_{KL} ( {P}_{c} ( t + 1 ) \vert \vert P ( t ) ) ,$$

where P_{c}(t+1) may be a probability map that is expected to represent the targets' locations at time t+1 when the agent may be located in cell c. Then, the next action may be chosen as in Eq. B29, below:

$$Eq . B 28$$

$$𝕒 ( t + 1 ) = arg {max}_{𝕒 ∈ 𝔸} d ( COV ( t ) , 𝕒 ( c ( t ) ) ) ,$$

where d(COV(t), [symbol] (c(t))) may be the distance between the center of view COV(t) and cell [symbol] (c(t)), to which the agent moves from its current location c(t) when it executes action [symbol] . Note that in contrast to the next location c(t+1), which is one of the neighboring cells of the current agent location c(t), the center of view COV(t) may be a cell that is chosen from among all n cells of the domain.

In a third algorithm, the next action may be chosen as in Eq. B30, below:

$$Eq . B 30$$

$$𝕒 ( t + 1 ) = arg {max}_{𝕒 ∈ 𝔸} d ( COG ( t ) , 𝕒 ( c ( t ) ) ) ,$$

here COG(t) stands for the “center of gravity”, which may be the first moment of the probability map P(t), and the remaining terms have the same meanings as above.

The Q-max and SPL algorithms used the same neural network as above and were initialized with the same parameters. As above, for all the algorithms, the agent started in the initial position c(0)=(9,4) and moved over the domain with the aim of detecting ξ=2 targets.

The first simulations addressed the detection of static targets, which, as above, were located at points (5,0) and (0,9).

The results of the detection by different algorithms are summarized in Table 1. The results represent the averages over 30 trials for each algorithm.

TABLE 1
Number of agent actions and the discounted cumulative
information gain in detecting two static targets
for the false alarm rate α = 0.5.

| | Number of Actions | Number of Actions | Discounted |
|---|---|---|---|
| Detection | up to Detection of | up to Detection of | Cumulative |
| Algorithm | the First Target | the Second Target | Information Gain |
| Random | 25 | 45 | 13.4 |
| EIG | 17 | 27 | 17.1 |
| COV | 17 | 24 | 17.5 |
| COG | 18 | 29 | 16.1 |
| Q-max | 15 | 21 | 20.5 |
| SPL | 14 | 21 | 20.1 |

The table shows that the proposed Q-max and SPL algorithms outperform previously developed methods in terms of both the number of agent actions and the value of the discounted cumulative information gain.

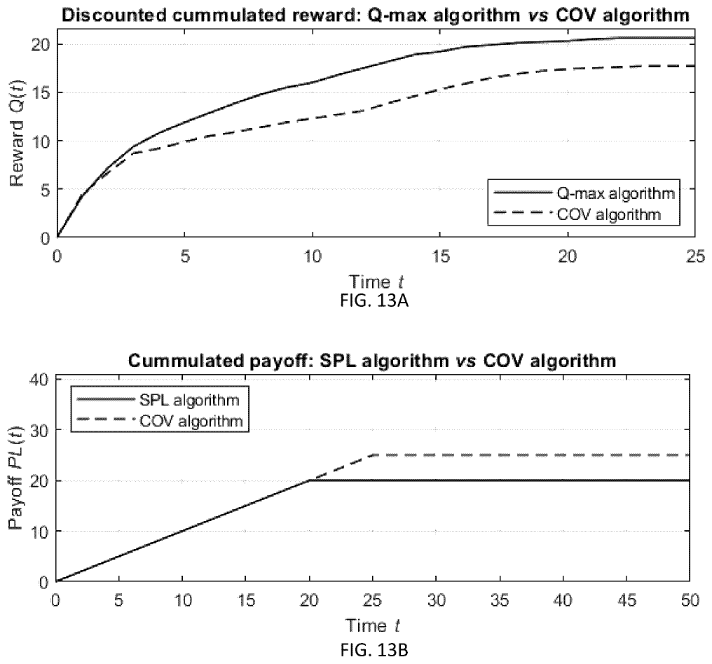

The results of the simulations over time are shown in FIGS. 13A and 13B. FIG. 13A, is a graph depicting the discounted cumulative reward 250Q for the Q-max algorithm in comparison with the COV algorithm (the best heuristic algorithm) and the random detection process, according to some embodiments of the invention. FIG. 13B, is a graph depicting similar graphs for the SPL algorithm compared to the COV algorithm and the random detection process, according to some embodiments of the invention.

FIG. 13A shows cumulative reward 250Q of detection by the Q-max algorithm for static targets, FIG. 13B shows and cumulative payoff of detection by the SPL algorithm for static targets compared with the results obtained by the COV algorithm.

The detection by the suggested algorithms may be better than the detection by the COV algorithm. In this example, the Q-max algorithm results in 20.5 units of discounted cumulative reward 250Q, while the COV algorithm obtains 17.5 units of discounted reward 250Q in the same number of steps. In other words, the Q-max algorithm may be nearly 1.15 times more effective than the COV algorithm. Similarly, while the COV algorithm requires 25 steps to detect the targets, the SPL algorithm requires only 20 steps, which means that the SPL algorithm may be 25% better than the COV algorithm.

The second simulations addressed the detection of moving targets, which started in the initial positions (5,0) and (0,9). Regarding the targets' motion, it is assumed that both of them, at each time t=1, 2, . . . , can apply one of the possible actions from the set [symbol] ={↑, [symbol] , →, [symbol] , ↓, [symbol] , ←, [symbol] , ⊙} so that the probability of the action ⊙ is Pr{ [symbol] (t)=⊙}=0.9 and the probability of each other action [symbol] ∈ [symbol] \⊙ is (1−0.9)/8=0.0125.

The results of detection by different algorithms (averaged over 30 trials for each algorithm) are summarized in Table 2.

TABLE 2
Number of agent actions and the discounted cumulative
information gain in detecting two moving targets for
the false alarm rate α = 0.5.

| | Number of Actions | Number of Actions | Discounted |
|---|---|---|---|
| Detection | up to Detection of | up to Detection of | Cumulative |
| Algorithm | the First Target | the Second Target | Information Gain |
| Random | 72 | 105 | 21.8 |
| EIG | 50 | 65 | 27.1 |
| COV | 49 | 62 | 28.7 |
| COG | 55 | 67 | 26.2 |
| Q-max | 32 | 45 | 33.2 |
| SPL | 31 | 43 | 32.1 |

In the detection of moving targets, the suggested Q-max and SPL algorithms also outperform previously developed methods in terms of both the number of agent actions and the value of the discounted cumulative information gain.

Note that the simulation was conducted for targets with a clear motion pattern, where the probabilities of the targets' actions represent slow random motion of the targets near their initial locations. Another possible reasonable motion pattern may be motion with a strong drift in a certain direction, which results in a similar ratio between the numbers of actions and the discounted cumulative information gains to that presented in Table 2.

In contrast, if the random motion of the targets is a random walk with equal probabilities Pr{ [symbol] (t)= [symbol] }=1/9 for all actions [symbol] ∈ [symbol] , then the training becomes meaningless since both with and without training, the agent needs to detect randomly moving targets.

The other results obtained for the Q-max/SPL algorithms also indicated better performance by these algorithms compared with that of the heuristic algorithms. The algorithms were compared with the best heuristic COV algorithm. The results of the trials for different values of the false alarm rate α and of the sensor sensitivity A are summarized in Table 3.

TABLE 3
The number of agent actions in detecting two static
targets for different values of the false alarm
rate α and of the sensor sensitivity λ.

| | |
|---|---|
| Sensor | False Alarm Rate |

| Sensitivity | Algorithm | α = 0.25 | α = 0.5 | α = 0.75 |
|---|---|---|---|---|
| λ = 15 | COV | 14 | 25 | 63 |
| | SPL/Q-max | 13 | 20 | 45 |
| | (average) | | | |
| λ = 5 | COV | 64 | 95 | 242 |
| | SPL/Q-max | 44 | 54 | 63 |
| | (average) | | | |

For all values of the false alarm rate and the sensor sensitivity, the Q-max and SPL algorithms strongly outperform the best heuristic COV algorithm.

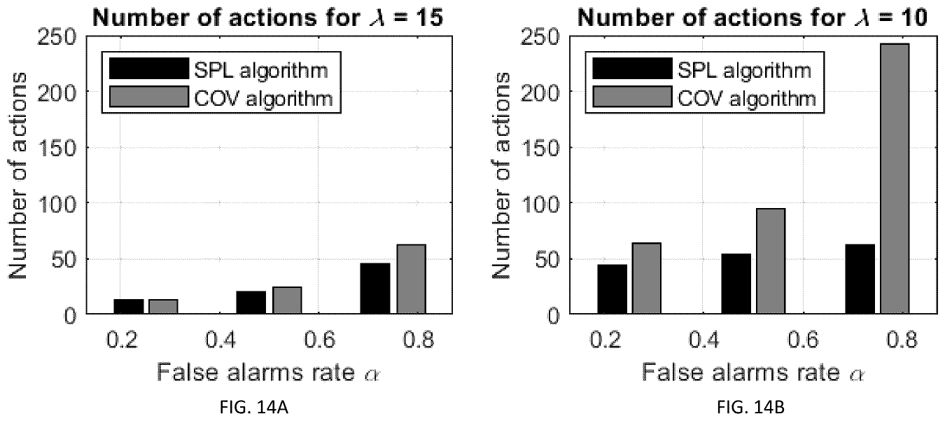

To emphasize the difference in the detection time between the suggested SPL and Q-max algorithms and the heuristic COV algorithm, the data shown in the table are depicted in FIGS. 14A, 14B.

Reference is now made to FIG. 14A and FIG. 14B which are column graphs depicting the number of agent actions in detecting two static targets with the SPL/Q-max algorithms (black bars) and the COV algorithm (gray bars). In FIG. 14A, λ=15, and in FIG. 14B λ=10.

In this example, the Q-max and SPL learning algorithms demonstrate better performance than the heuristic COV algorithms without learning, and the difference between the algorithms increases as the false alarm rate α increases and the sensor sensitivity A decreases. For example, if λ=15 and α=0.25, then the improvement in the number of actions may be 10%, while if λ=5 and α=0.75, then the improvement may be significantly stronger at 75%.

In other words, computationally inexpensive heuristic algorithms provide effective results in searches with accurate sensors and a low rate of false alarms. However, in searches with less precise sensors or with a high rate of false-positive errors, the heuristic algorithms may be less effective, and the Q-max and SPL learning algorithms may be applied.

### Comparison Between the SPL Algorithm and an Algorithm Providing the Optimal Solution.

The suggested approach was compared with the known dynamic programming techniques implemented in search algorithms for moving targets. Since the known algorithms directly address the optimal trajectory of the agent and result in an optimal path, in the simulation, we considered the SPL algorithm, which uses the same criteria as the known algorithms.

The comparisons were conducted as follows. The algorithms were trialed over the same domain with a definite number n of cells, and the goal was to reach the maximal probability P*=0.95 of detecting the target. When this probability was reached, the trial was terminated, and the number of agent actions was recorded.

Since known algorithms implement dynamic programming optimization over possible agent trajectories, their computational complexity may be high, and for the considered task, it is [symbol] (n·9^{t}), where n is the number of cells and t is the number of actions.

Therefore, to finish the simulations in reasonable time (120 min for each trial), the algorithms were trialed on a very small case with n=10×10=100 cells. Note that in the original simulations, these algorithms were trialed on smaller cases. If the desired probability P*=0.95 of detecting the targets was not reached in 120 min, the algorithms were terminated.

In all trials, the known dynamic programming algorithms planned t=7 agent actions in 120 min, while the suggested SPL algorithm, at the same time of 120 min, planned significantly more actions and reached at least the desired probability P*=0.95 of detecting the targets. The results of the comparison between the SPL algorithm and the known dynamic programming algorithms that provide optimal solutions are summarized in Table 4.

TABLE 4
Number of planned agent actions in detecting two static targets by the
SPL algorithm and dynamic programming (DP) algorithm for different values
of the false alarm rate α and of the sensor sensitivity λ.

| Sensor | | | False Alarm Rate | | | | | | | | | |
|---|---|---|---|---|---|---|---|---|---|---|---|---|
| Sensitivity | Algorithm | Characteristic | α = 0 | | α = 0.05 | | α = 0.1 | | α = 0.25 | | α = 0.5 | |
| λ = 15 | DP | Run time | 0.4 | s | 1 | min | 120 | min | 120 | min | 120 | min |
| | | Number of | 3 | | 5 | | 7 | | 7 | | 7 | |
| | | planned actions | | | | | | | | | | |
| | | Detection | 1.0 | | 1.0 | | 0.99 | | 0.90 | | 0.84 | |
| | | probabilities | | | | | | | | | | |
| | | p₁ and p₂ | 1.0 | | 0.99 | | 0.96 | | 0.84 | | 0.68 | |
| | SPL | Run time | 0.4 | s | 1 | min | 120 | min | 120 | min | 120 | min |
| | | Number of | 3 | | 5 | | 7 | | 13 | | 20 | |
| | | planned actions | | | | | | | | | | |
| | | Detection | 1.0 | | 1.0 | | 0.99 | | 0.99 | | 0.99 | |
| | | probabilities | | | | | | | | | | |
| | | p₁ and p₂ | 1.0 | | 0.99 | | 0.96 | | 0.95 | | 0.95 | |
| λ = 10 | DP | Run time | 1 | min | 120 | min | 120 | min | 120 | min | 120 | min |
| | | Number of | 5 | | 7 | | 7 | | 7 | | 7 | |
| | | planned actions | | | | | | | | | | |
| | | Detection | 1.0 | | 0.96 | | 0.90 | | 0.85 | | 0.71 | |
| | | probabilities | | | | | | | | | | |
| | | p₁ and p₂ | 1.0 | | 0.95 | | 0.85 | | 0.65 | | 0.43 | |
| | SPL | Run time | 1 | min | 120 | min | 120 | min | 120 | min | 120 | min |

| Number of | 5 | 7 | 15 | 21 | 32 |
|---|---|---|---|---|---|
| planned actions | | | | | |

| | | | | | |
|---|---|---|---|---|---|
| Detection | 1.0 | 0.96 | 0.97 | 0.98 | 0.99 |
| probabilities | | | | | |
| p₁ and p₂ | 1.0 | 0.95 | 0.95 | 0.95 | 0.95 |

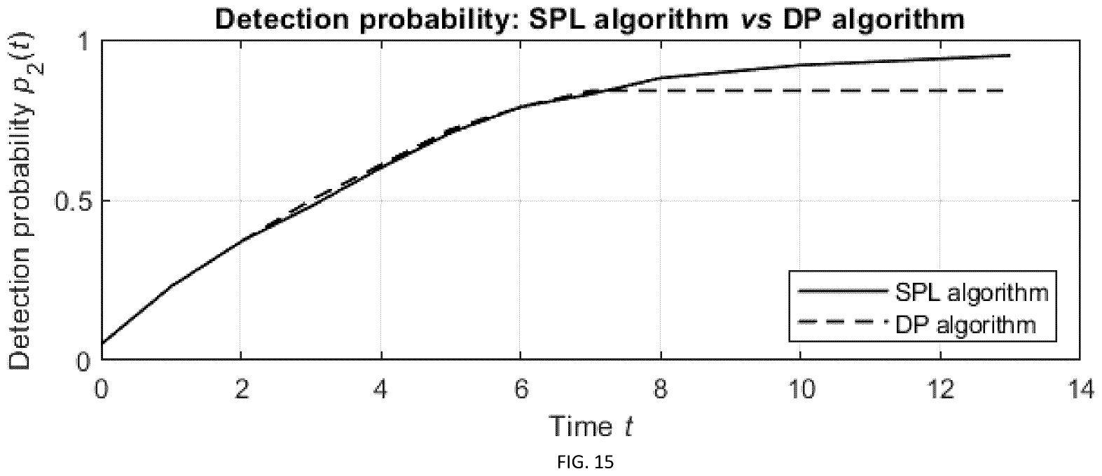

Until termination at 120 min, the SPL algorithm plans more agent actions and results in higher detection probabilities 240PV than the DP algorithm for both values of sensor sensitivity λ and for all values of the false alarm rate α. For example, the dependence of the detection probabilities 240PV on the run time for sensor sensitivity λ=15 and false alarm rate α=0.25 is depicted in FIG. 15.

Reference is now made to FIG. 15 which is a graph showing dependence of the detection probabilities 240PV on the number of planned actions for the SPL algorithm (solid line) and DP algorithm (dotted line), according to some embodiments of the invention. In the example of FIG. 15, the sensor sensitivity is λ=15, the false alarm rate is α=0.25, and the termination time is t=120 min.

For the first 7 actions, the detection probabilities 240PV of both algorithms increase similarly. Then, the DP algorithm does not plan additional actions in 120 min, while the SPL algorithm results in more planned actions, and the detection probabilities 240PV for these actions continue increasing until termination after 13 planned actions.

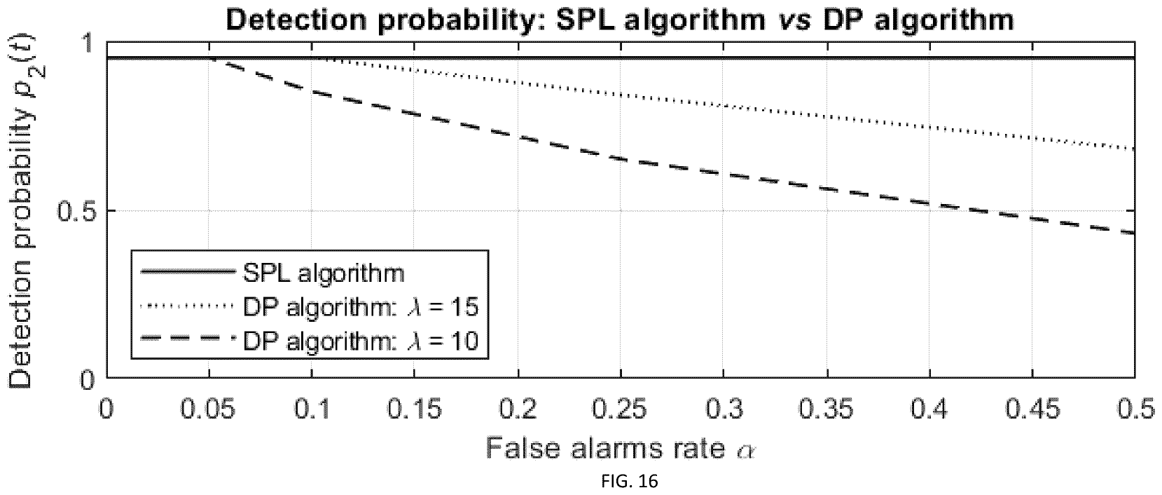

The dependence of the detection probabilities 240PV on the false alarm rate α at termination after 120 min is depicted in FIG. 16.

Reference is now made to FIG. 16 which is a graph showing dependence of the detection probabilities 240PV on the false alarm rate α for sensor sensitivities λ=15 (dotted line) and λ=10 (dashed line). The probability 0.95 for the SPL algorithm and all values of a is depicted by the solid line. The termination time is 120 min.

For a low false alarm rate α, the SPL algorithm results in the same detection probabilities 240PV as the optimal DP algorithms, but for a higher false alarm rate α, the detection probabilities 240PV obtained by the DP algorithms significantly decrease (to 0.68 and 0.43 for λ=15 and λ=10, respectively), while the probability obtained by the SPL algorithm may be 0.95 for any false alarm rate and both sensor sensitivities.

### Run Times and Mean Squared Error for Different Sizes of Data Sets

Finally, we considered the dependence of the run time and mean squared error on the size of the data set. The results of these simulations are summarized in Table 5.

TABLE 5
Run times and temporal difference errors
with respect to the size of the data set.

| | Number of Nonzero | Size of | Run Time for | Mean |
|---|---|---|---|---|
| Domain | Weights in the | the Data | One Epoch | Squared |
| Size nₓ × n_{y} | Neural Network | Set | [Minutes] | Error * |
| 10 × 10 | 42,009 | 5000 | 4 | 0.13 |
| | | 10,000 | 8 | 0.12 |
| 20 × 20 | 648,009 | 5000 | 7 | 0.15 |
| | | 10,000 | 14 | 0.13 |
| 40 × 40 | 10,272,009 | 5000 | 10 | 0.18 |
| | | 10,000 | 20 | 0.15 |

* The error was calculated over the temporal difference errors at the validation stage at epoch t = 30.

While the size of the domain and the number of links in the network exponentially increase, the mean squared error increases very slowly and remains small. In addition, it may be seen that with an exponentially increasing domain size, the run time increases linearly, and the computations require a reasonable time even on the previously described PC. However, for realistic engineering and industrial problems with larger domains, it may be reasonable to use computation systems with greater GPU power.

Embodiments of the invention may include a novel algorithm for the navigation of mobile agents detecting static and moving hidden targets in the presence of false-positive and false-negative errors. In contrast to currently available systems for detection of targets, which follow an immediate one-step decision making process, embodiments of the present invention may implement a deep Q-learning approach and neural network techniques.

Embodiments of the invention may implement the suggested algorithm in two versions: a procedure that maximizes the cumulative discounted expected information gain over the domain (Q-max algorithm) and a procedure that minimizes the expected path length of the agent in detecting all the targets (SPL algorithm).

The simulations show that after offline training of the neural network using the generated data set, the algorithm provides solutions that outperform the results obtained by the previously developed procedures, both in terms of the cumulative information gain and in terms of the agent's path length. Moreover, the expected number of actions obtained by the Q-max algorithm by maximizing the cumulative discounted expected information gain may be statistically equal to the number of actions obtained by the SPL algorithm by minimizing the expected path length. This equivalence follows directly from the nature of the problem: in terms of information, the detection of the targets means accumulating as much information as possible about the targets' locations, and in terms of the path length, the detection of the targets means making as few movements as possible in order to specify the exact target locations.

Embodiments of the invention may consider the detection problem for multiple static and moving targets hidden in a domain.

In the exploration stage, the suggested algorithm may implement the deep Q-learning approach and may apply neural network techniques for learning the probabilities 240PV of the targets' locations and their motion patterns; then, in the exploitation stage, it may choose actions based on the decisions made by the trained neural network.

The research suggested two possible procedures. In the first, called the model-free procedure, the agent detects the targets in the environment and simultaneously, online, learns the environment and trains a neural network that supports the agent's decision-making processes. In the second procedure, called the model-based procedure, the agent begins detection only after offline learning and requires an exact model of the targets' activity.

The results obtained by maximizing the discounted cumulative expected information gain and by minimizing the expected length of the agent's path demonstrate that the suggested algorithm outperforms previously developed information-based procedures and provides a nearly optimal solution even in cases in which the existing techniques require an unreasonable computation time.

The proposed algorithms were implemented in the Python programming language and can be used both for further development of the methods of probabilistic search and detection and for practical applications in the appropriate fields.

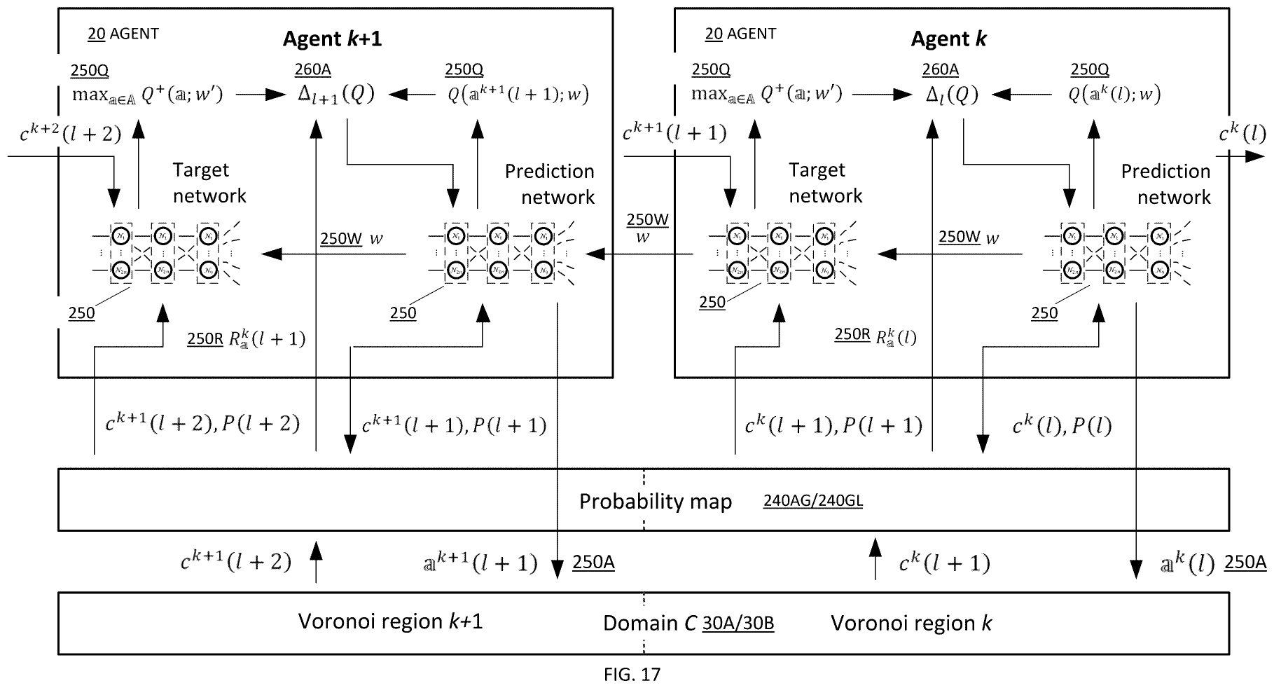

Reference is now made to FIG. 17 which is a schematic block diagram depicting actions of an offline model-based learning procedure, implementing a Q-max algorithm, according to some embodiments of the invention.

As shown in FIG. 17, system 10 may include a plurality of agents 20, configured to work by turns or iterations, as in a relay race, where each turn may be dedicated to movement of a specific subset (e.g., one or more) of agents 20.

In the example of FIG. 17, two agents 20 are shown, enumerated k and k+1. A prediction NN 250 of the k^{th} agent may be used for choosing the action and specifying the expected position of this agent at step l, while the target network 250 of the kth agent may be used for calculating the reward 240R after selecting and conducting the action that leads to step l+1. Then, the cumulative reward 250Q calculated by target network 250 may be used to update prediction network 250, and its weights 250W may then be used to update the weights 250W of the trained network 250. Note that together with the position of the k^{th} agent, target network 250 may consider the position of the (k+1)^{th} agent 20. Target network 250 of the k^{th} agent, which at step l was trained with respect to the positions 30A/30B of the kth and (k+1)^{th} agents, may be considered a prediction network 250 of the (k+1)^{th} agent at step l+1.

As explained herein, the prediction network 250 and target network 250 may be represent the same entity for each agent 20, at different phases or stages. Additionally, or alternatively, prediction network 250 and target network 250 may represent the same entity for a plurality (e.g., all) of agents 20. Accordingly, prediction network 250 and target network 250 may both be enumerated as entity 250. Additionally, or alternatively, prediction network 250 and target network 250 may be implemented as separate entities within at least one agent 20, or among agents 20.

At a learning stage, agents 20 may share the probability map 240GL/240AG and one or more (e.g., each) of the agents may update the probability values 240PV of the targets' locations over the entire domain. In addition, a reward 240R of the kl agent 20 may be calculated over its Voronoi region. The Voronoi diagram may be updated after updating the positions and the probability map by all η agents.

In the above definitions, the cumulative rewards 250Q may not depend on the previous trajectories of the agents 20, and the process that governs the activity of each agent may be a Markov process with states that include the positions of the agent 20 and the probability maps 240GL/240AG. This property allows the use of the offline learning procedure. In this process, at step l, the networks may use the probabilities of the expected targets' locations 240PV Pr{s(cᵢ, l)=1|s(cᵢ, l−1)=1} and Pr{s(cᵢ, l)=1|s(cᵢ, l−1)=0} at step l given the states of the cells at the previous step l−1. These probabilities may be defined as follows using a Bayesian scheme, as in equations Eq. B31 and Eq. B32 below:

$$Eq . B 31$$

$$\begin{matrix}Pr \{ s ( {c}_{i} , l ) = 1 \vert s ( {c}_{i} , l - 1 ) = 1 \} = \\ = \frac{{p}_{i} ( l - 1 ) {p}_{TA} exp [ - d ( {c}_{i} , {c}_{j} ) / {λ}^{k} ]}{{p}_{1} ( l - 1 ) ( 1 - α ) + α} + \frac{{p}_{i} ( l - 1 ) {( 1 - exp [ - d ( {c}_{i} , {c}_{j} ) / {λ}^{k} ] )}^{2}}{\begin{matrix}{p}_{i} ( l - 1 ) ( 1 - {p}_{TA} exp [ - d ( {c}_{i} , {c}_{j} ) / {λ}^{k} ] ) + \\ ( 1 - {p}_{i} ( l - 1 ) ) ( 1 - α {p}_{TA} exp [ - d ( {c}_{i} , {c}_{j} ) / {λ}^{k} ] )\end{matrix}}\end{matrix}$$

$$Eq . B 32$$

$$\begin{matrix}Pr \{ s ( {c}_{i} , l ) = 1 \vert s ( {c}_{i} , l - 1 ) = 0 \} = \\ = \frac{{p}_{i} ( l - 1 ) α {p}_{TA} exp [ - d ( {c}_{i} , {c}_{j} ) / {λ}^{k} ]}{{p}_{1} ( l - 1 ) ( 1 - α ) + α} + \frac{\begin{matrix}{p}_{i} ( l - 1 ) ( 1 - exp [ - d ( {c}_{i} , {c}_{j} ) / {λ}^{k} ] ) \\ ( 1 - α {p}_{TA} exp [ - d ( {c}_{i} , {c}_{j} ) / {λ}^{k} ] )\end{matrix}}{\begin{matrix}{p}_{i} ( l - 1 ) ( 1 - {p}_{TA} exp [ - d ( {c}_{i} , {c}_{j} ) / {λ}^{k} ] ) + \\ ( 1 - {p}_{i} ( l - 1 ) ) ( 1 - α {p}_{TA} exp [ - d ( {c}_{i} , {c}_{j} ) / {λ}^{k} ] )\end{matrix}}\end{matrix}$$

At a learning stage, the targets' location probabilities 240PV may be specified by the following condition, as in equation Eq. B33, below:

$$\begin{matrix}Eq . B33 & \\ {p}_{i} ( l ) = \{ \begin{matrix}Pr \{ s ( {c}_{i} , l ) = 1 \vert s ( {c}_{i} , l - 1 ) = 1 \} if the target was in {c}_{i} at l - 1 , \\ Pr \{ s ( {c}_{i} , l ) = 1 \vert s ( {c}_{i} , l - 1 ) = 0 \} if the target was not in {c}_{i} at l - 1.\end{matrix} & ( 23 )\end{matrix}$$

The learning process may be terminated when the updated probability map P(l) becomes equal to the objective map P*. The detection process can terminate either when the updated probability map P(t) becomes equal to the objective map P* or when all 5 targets are detected.

The collective Q-max algorithm for the detection of multiple targets may include two stages: a learning stage, during which the agents' neural network(s) 250 are trained, and the acting stage, which is an application of the agents (with the trained neural networks) for detecting the targets. The algorithm is outlined as follows in

Algorithm 3. Collective detection with deep learning: collective Q-max
algorithm.

Network structure:

input layer: 2n neurons (n agent positions and n target location
probabilities, both relative to the size n of the domain),
hidden layer: 2n neurons,
output layer: 9 neurons (in accordance with the number of
possible actions).

Activation function:

asymmetric sigmoid function f(x) = 1/(1 + e^{-x}).

Loss function:

| | |
|---|---|
| | mean square error (MSE) function. |
| Input: | domain C = {c₁, c₂, ... , cₙ}, |
| | number of agents η, |
| | sensor sensitivities λ¹, λ², ... , λ^{η}, |
| | initial agents′ positions c¹(0), c²(0), ... , c^{η}(0), |
| | set [symbol] = {↑, [symbol] , →, [symbol] , ↓, [symbol] , ←, [symbol] , ⊙} of possible actions, |
| | probability p_{TA} of true alarms, |
| | rate α of false alarms and their probability p_{FA} = αp_{TA}, |
| | initial probability map P(0)= {p₁(0), p₂(0), ... , pₙ(0)} on the domain C, |
| | objective probability map P*, |
| | number of targets ξ (or objective probability map P*). |
| Output: | target locations ĉ¹(T), ĉ²(T), ... , ĉ^{ξ}(T) at a termination time T. |

```
Learning
  1. Generate training data set: agents′ positions c(0) =
    (c¹(0), c²(0), ... , c^{η}(0)),
  2. For each agent k = 1, ... , η do:
  3. Create the prediction network.
  4. Create the target network as a copy of the prediction network.
  5. End for.
  6. Start with l = 0.
  7. For each pair (c, P) from the training dataset, do:
  8. Create the Voronoi diagram [symbol] (l) = {C¹(l), C²(l), ... , C^{η}(l)}.
  9. Create the probability atlas [symbol] (l) = {P¹(l), P²(l), ... , P^{η}(l)}.
10. For each agent k = 1, ... , η do:
11. For each action [symbol]  ∈ [symbol]  do:
12. Calculate the value Q(c^{k}(l), P(l), [symbol] (l)) by the prediction network.
13. Choose action [symbol] (l) by the value p( [symbol]  |Q; θ) and the SoftMax policy.
14. Apply the chosen action to the current position c^{k}(l) and obtain
          the next position c^{k}(l + 1).
15. Update the probability map P(l) to P(l + 1).
16. If P(l + 1) = P*, then
17.  $Set immediate reward {R}_{𝕒}^{k} ( l ) = 0.$
18. Set cumulative reward Q(c^{k}(l), P(l), [symbol] (l), w) = 0.
19. Else
20.  $Calculate immediate reward {R}_{𝕒}^{k} ( l ) with respect to$
            probabilities the agent’s parts P^{k}(l) ∈ [symbol] (l) and P^{k}(l + 1) ∈ [symbol]
            (l) of the probability map. {The Voronoi diagram and so -
            the cells associated with the kth agent remain, but the
            values of the probabilities change.}
21. End if.
22. End for.
23. Calculate the values Q⁺(c^{k}(l + 1), P(l + 1), [symbol] ; w′) by the target
        network.
24. Calculate the temporal difference learning error Δₗ(Q) for
        maximal Q⁺.
25. Update the prediction network with respect to the error Δₗ(Q).
26. Update the target network by the weights of the prediction
        network.
27. Update the prediction network of the (k +1)th agent by the target
        network of the kth agent.
28. End for.
29. If the training epochs ended
30. For each agent k = 1, ... , η do:
31. Update the target network by the target network of the ηt
          agent.
32. End for.
33. Start acting (go to line 36).
34. End if.
35. End for
Acting
36. Start with t = 0.
37. Obtain the initial agents′ positions c¹(t), c²(t), ... , c^{η}(t).
38. Obtain the initial probability map P(t) = {p₁(t), p₂(t), ... , pₙ(t)}.
39. For each agent k = 1, ... , η do:
40. Get the values Q(c^{k}(t), P(t), [symbol] (t), w) using the trained network.
41. Choose action [symbol] (t), which provides the maximum Q(c^{k}(t), P(t), [symbol] (t), w).
42. Apply the chosen action to the current position c^{k}(t) and obtain
      the next position c^{k}(t + 1).
43. Screen the domain C. {The kth agent screens all the domain C with
      respect to the abilities of the on-board sensors.}
44. Update the targets′ locations ĉ¹(t), ĉ²(t), ... , ĉ^{ξ}(t).
45. Update the probability map P(t) to P(t + 1).
46. End for.
47. If all ξ targets were detected (or if P(t) = P*), then
48. Set T = t and terminate (go to line 32).
49. Else
50. Set t = t + 1.
51. Continue detection (go to line 39).
52. End if.
53. Return targets′ locations ĉ¹(T), ĉ²(T), ... , ĉ^{ξ}(T).
```

Instead of using individual prediction and target networks, algorithm 3 may consider the prediction network 250 of the next agent 20 as its target network. Thus, each agent 20 may use the training results of the previous agent 20 and share its knowledge with the next agent.

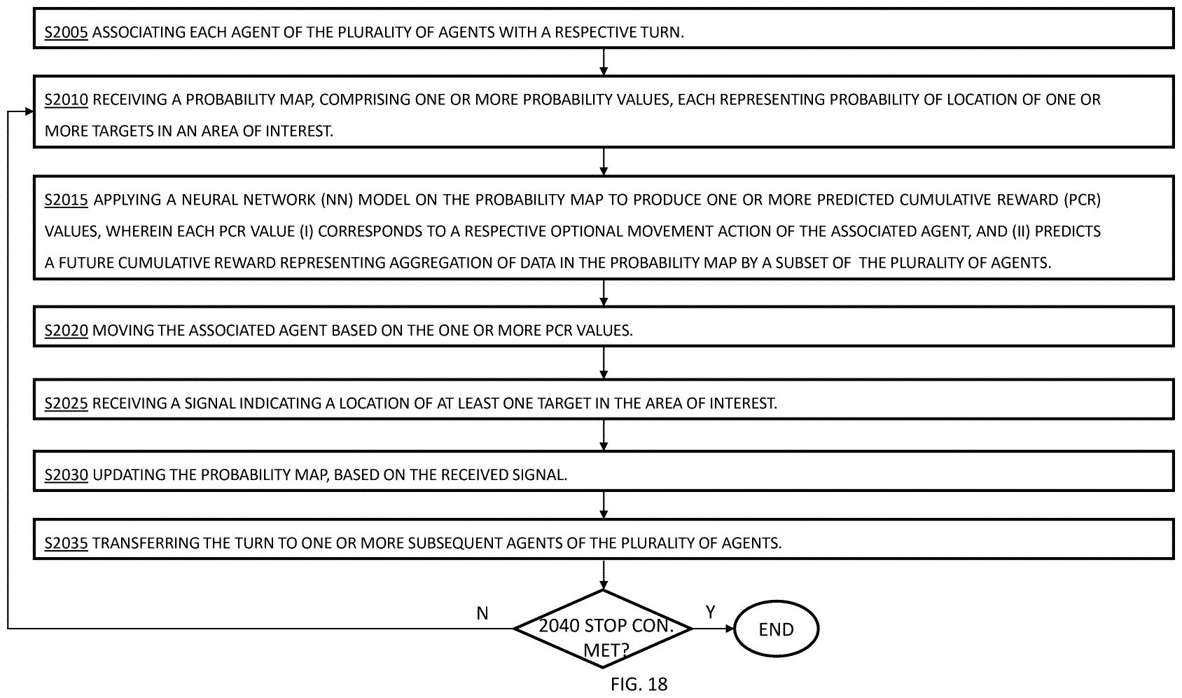

Reference is now made to FIG. 18, which is a flow diagram depicting a method of distributed controlling of movement of a plurality of agents (e.g., agents 20 of FIG. 3), according to some embodiments of the invention. The term “distributed” may be used in this context to indicate parallel implementation by one or more processors (e.g., processor 2 of FIG. 1), pertaining to the different agents 20.

According to some embodiments, and as shown in step S2005, agents 20 may be arranged in an order, or queue such as a daisy-chain sequence, where each agent may be associated with a respective turn. For example, agents 20 may be assigned a serial number via input 7 of FIG. 1. Additionally, or alternatively, agents 20 may communicate via a communication network (e.g., a cellular network, the Internet, and the like) and may assign such serial numbers or turns via negotiation.

As shown in FIG. 18, at each turn a processor of the associated agent 20 may perform steps S2010-S2035, until a stop condition is met (step S2040). Such a stop condition may include, for example, detection of a required number of targets, as elaborated herein.

As shown in step S2010, the associated agent 20 may receive or obtain a probability map such as map 240AG/240GL of FIG. 4. As elaborated herein (e.g., in relation to FIG. 4), probability map 240AG/240GL may include one or more probability values (e.g., probability values 240PV of FIG. 3), each representing probability of location of one or more targets in an area of interest.

As shown in step S2015, and elaborated herein (e.g., in relation to FIG. 5) the associated agent 20 may apply a Neural Network (NN) model 250 on probability map 240AG/240GL, to produce one or more Predicted Cumulative Reward (PCR) values, also denoted herein as ‘Q’ values 250Q. Each PCR value 250Q may correspond to a respective optional movement action such as action element 250A, or ‘A’ of FIG. 5 of the associated agent. Additionally, or alternatively, Each PCR value 250Q may predict a future cumulative reward, representing aggregation of data in the probability map 240AG/240GL by a subset (e.g., two or more) of the plurality of agents.

For example, the associated agent 20 may, during its turn, calculate PCR values 250Q resulting from future actions of other agents 20, as well as its own, in response to each optional action 250A.

As shown in step S2020, a processor of the associated agent 20 may control a driver 210 of at least one actuator or motor 210′ to move the associated agent 20 based on the one or more PCR values 250Q. For example, the processor of the associated agent 20 may select the optional movement action (e.g., “move right for a predefined distance”) that corresponds to the maximal PCR value 250Q, and control the appropriate actuator or motor 210′ to move according to that selection.

As shown in step S2025, the associated agent 20 may receive, e.g., from sensor(s) 220 of FIG. 3 (e.g., a radar, a metal detector, and the like) a signal 220A, also referred to herein as target signal 220A. Signal 220A may indicate a location of at least one target in the area of interest.

As shown in step S2030, the associated agent 20 may update probability map 240AG/240GL based on the received signal, as elaborated herein (e.g., in relation to FIG. 4).

As shown in step S2035, the associated agent 20 may subsequently transfer the turn to one or more subsequent agents 20 of the plurality of agents 20. For example, the associated agent may transmit information such as weights 250W of NN model 250 and/or the updated probability map 240AG/240GL to one or more subsequent agents 20 of the plurality of agents. The one or more subsequent agents 20 may, in turn perform steps S2010-S2035, until the stop condition is met (step S2040). By sharing information such as weights 250W of NN model 250 and/or updated probability map 240AG/240GL, agents 20 may collaborate as in a relay race: In each relay, a relevant agent 20 may (a) select an optional movement action that corresponds to a maximal or optimal movement action that would benefit the cumulative reward of one or more (e.g., all) agents (corresponding to a maximal PCR value of the one or more PCR values), including itself, (b) move according to that selected optimal movement action, and (c) pass the turn to one or more subsequent agents.

Additionally, or alternatively, as elaborated herein, e.g., in relation to FIG. 17, at each turn the processor 2 of the associated agent 20 may be configured to calculate an error value 260A (also referred to herein as al (Q)) and retrain, or refine the weights 250W of NN 250.

For example, the processor 2 of the associated agent 20 may calculate an instant reward value 250R (also referred to as ‘R’), representing addition of data in probability map 240AG/GL as a result of moving the associated agent 20. As elaborated herein, based on the instant reward value 250R, processor 2 of the associated agent 20 may calculate a revised PCR value 250Q (also referred to herein as ‘Q’), that corresponds to the selected optional movement action (e.g., an updated value of PCR 250Q, following movement of agent 20). processor 2 of the associated agent 20 may calculating the difference value 260A (Δₗ(Q)) between the maximal PCR value 250Q (‘Q’) and the revised PCR value 250Q (‘Q⁺’) and use the error value as feedback for NN 250, e.g., to retrain NN model 250 based on said difference.

1. A method of iteratively controlling movement of a plurality of agents by a corresponding plurality of processors, wherein each iteration comprises:
receiving, by at least one agent, an initial probability map, comprising one or more probability values, each representing probability of location of one or more targets in an area of interest;
applying, by the at least one agent, a Neural Network (NN) model on the probability map to produce, based on the one or more probability values, one or more Predicted Cumulative Reward (PCR) values, wherein said PCR values (i) correspond to respective one or more optional movement actions of the at least one agent, and (ii) predict a future cumulative reward representing aggregation of data in the probability map by the plurality of agents;
selecting, by the at least one agent, a movement action of the one or more optional movement actions, based on the PCR values;
moving the at least one agent according to the selected movement action;
receiving, by the at least one agent, from at least one first sensor associated with the agent, a target signal indicating a location of at least one target of the one or more targets; and
updating the probability map by the at least one agent, based on the received target signal.

2. The method of claim 1, wherein each iteration further comprises receiving, from at least one second sensor associated with the agent, at least one location data element, representing a respective location of the at least one agent.

3. The method of claim 2, wherein the NN model is configured to produce the one or more PCR values based on the probability map and the at least one location data element.

4. The method of claim 2, wherein each iteration further comprises:
calculating a reward value, representing an amount of data that is added in the updated probability map following the movement of the at least one agent;
based on the reward value, calculating an error value that corresponds to the selected movement action, wherein said error value represents an error in the predicted PCR value; and
updating one or more weights of the NN model so as to minimize the error value.

5. The method of claim 3 wherein each iteration corresponds to movement of a specific, respective agent, and wherein each iteration further comprises:
moving the respective agent according to the selected movement action;
updating the weights of the NN model based on the reward value, as calculated following movement of the respective agent; and
distributing the updated weights of the NN model among the plurality of agents.

6. The method of claim 1, wherein each iteration corresponds to movement of a specific, respective agent, and wherein each iteration further comprises:
moving the respective agent according to the selected movement action;
updating the probability map based on the target signal of the respective agent; and
distributing the updated probability map among the plurality of agents.

7. The method of claim 3, wherein each iteration corresponds to movement of a specific, respective agent, and wherein each iteration further comprises:
distributing the location data elements of the respective agent, among the plurality of agents; and
further applying the NN model on the location data elements of two or more agents, to produce said PCR values.

8. The method of claim 1, wherein each iteration corresponds to movement of a specific, first agent, and wherein each iteration further comprises selecting a second agent for a subsequent iteration, based on at least one of: (i) a distance of the first agent from a predefined location in the area of interest, (ii) a distance of the second agent from a predefined location in the area of interest, and (iii) a distance between the first agent and the second agent.

9. The method of claim 1, wherein the NN is a reinforcement learning network, and wherein each PCR value represents a cumulative value of rewards of future iterations, that is expected until a predefined stop condition is met.

10. The method of claim 9, wherein the stop condition comprises having a predefined number of targets represented in the probability map, by a respective number of probability values, that exceed a predefined threshold.

11. A system for iteratively controlling at least one agent of a plurality of mobile agents, wherein each agent comprises a non-transitory memory device, wherein modules of instruction code are stored, and at least one processor associated with the memory device, and configured to execute the modules of instruction code, whereupon execution of said modules of instruction code, the at least one processor is configured to:
receive an initial probability map, comprising one or more probability values, each representing probability of location of one or more targets in an area of interest;
apply a Neural Network (NN) model on the probability map to produce, based on the one or more probability values, one or more Predicted Cumulative Reward (PCR) values, wherein each PCR value (i) corresponds to respective one or more optional movement actions of the at least one agent and (ii) predicts a future cumulative reward representing aggregation of data in the probability map by the plurality of agents;
select a movement action of the one or more optional movement actions, based on the PCR values;
move the at least one agent according to the selected movement action;
receive, from at least one first sensor associated with the agent, a target signal indicating a location of at least one target of the one or more targets; and
update the probability map, based on the received target signal.

12. (canceled)

13. (canceled)

14. (canceled)

15. (canceled)

16. The system of claim 11, wherein each iteration corresponds to movement of a specific, respective selected agent, and wherein the at least one processor of the selected agent is configured to, in each iteration:
move the respective agent according to the selected movement action;
update the probability map based on the target signal of the respective agent; and
distribute the updated probability map among the plurality of agents.

17. The system of claim 11, wherein each iteration corresponds to movement of a specific, respective selected agent, and wherein the at least one processor of the selected agent is configured to, in each iteration:
distribute the location data elements of the respective agent, among the plurality of agents; and
further apply the NN model on the location data elements of two or more agents, to produce said PCR values.

18. The system of claim 11, wherein the at least one agent comprises a swarm of agents, and wherein each iteration corresponds to movement of a specific, first agent of the swarm, and wherein each iteration further comprises selecting, by the one or more agents the swarm a second agent for a subsequent iteration, based on at least one of: (i) a distance of the first agent from a predefined location in the area of interest, (ii) a distance of the second agent from a predefined location in the area of interest, and (iii) a distance between the first agent and the second agent.

19. The system of claim 11, wherein the NN is a reinforcement learning network, and wherein each PCR value represents a cumulative value of rewards of future iterations, that is expected until a predefined stop condition is met.

20. (canceled)

21. A method of distributed controlling of movement of a plurality of agents, wherein the method comprises:
associating each agent of the plurality of agents with a respective turn;
at each turn, performing the following steps by a processor of the associated agent:
receiving a probability map, comprising one or more probability values, each representing probability of location of one or more targets in an area of interest;
applying a Neural Network (NN) model on the probability map to produce one or more Predicted Cumulative Reward (PCR) values, wherein each PCR value (i) corresponds to a respective optional movement action of the associated agent, and (ii) predicts a future cumulative reward representing aggregation of data in the probability map by a subset of the plurality of agents;
moving the associated agent based on the one or more PCR values;
receiving a signal indicating a location of at least one target in the area of interest;
updating the probability map, based on the received signal; and
transferring the turn to one or more subsequent agents of the plurality of agents.

22. The method of claim 21, wherein moving the associated agent comprises:
selecting an optional movement action that corresponds to a maximal PCR value of the one or more PCR values; and
moving the associated agent according to the selected optional movement action.

23. The method of claim 21, wherein at each turn the processor of the associated agent is further configured to:
calculate an instant reward value, representing addition of data in the probability map as a result of moving the associated agent;
based on the instant reward value, calculate a revised PCR value that corresponds to the selected optional movement action;
calculate a difference between the maximal PCR value and the revised PCR value; and
retrain the NN model based on said difference.

24. The method of claim 21, wherein the subset comprises two or more agents of the plurality of agents.

25. The method of claim 21 wherein transferring the turn comprises:
transmitting, by the associated agent, at least one of: (i) weights of the NN model, and (ii) the updated probability map, to the one or more subsequent agents of the plurality of agents; and
performing said steps by one or more processors of the one or more subsequent agents.
